(19) United States
(12) Patent Application Publication
(10) Pub. No.: US 2025/0016560 A1
(43) Pub. Date: Jan. 9, 2025

(54) METHOD AND DEVICE FOR AUTHENTICATING UE IN WIRELESS COMMUNICATION SYSTEM

(71) Applicant: LG ELECTRONICS INC., Seoul (KR)

(72) Inventors: Dongjoo KIM, Seoul (KR); Anbin KIM, Seoul (KR)

(73) Assignee: LG ELECTRONICS INC., Seoul (KR)

(21) Appl. No.: 18/698,726

(22) PCT Filed: Jan. 26, 2022
(86) PCT No.: PCT/KR2022/001377

§ 371 Date: Aug. 21, 2024

(30) Foreign Application Priority Data
Oct. 7, 2021 (KR) 10-2021-0133346

(51) Int. Cl. H04W 12/06; H04W 12/63

(52) U.S. Cl. CPC H04W 12/06; H04W 12/63

(57) ABSTRACT

A method for authenticating a UE in a wireless communication system disclosed herein may comprise: a step in which a first UE receives authentication mode information, wherein a second UE relaying the first UE also receives the authentication mode information, and the first UE, on the basis of the authentication mode information, requests information necessary for direct search between UEs; a step in which the first UE receives the information necessary for direct searches between UEs; and a step for connecting to a network and performing authentication via the second UE on the basis of the received information necessary for direct searches between the UEs.

### CROSS-REFERENCE TO RELATED APPLICATION(S)

This application is the National Stage filing under 35 U.S.C. 371 of International Application No. PCT/KR2022/001377, filed on Jan. 26, 2022, which claims the benefit of earlier filing date and right of priority to Korean Application No. 10-2021-0133346, filed on Oct. 7, 2021, the contents of which are all incorporated by reference herein in their entirety.

### TECHNICAL FIELD

The present disclosure relates to a wireless communication system, and more particularly, to a method for performing authentication of a user equipment (UE). Specifically, the present disclosure relates to a method for performing authentication of a remote UE that performs communication with a core network based on a UE-to-network relay.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as a large number of communication devices require a large communication capacity, the enhanced mobile broadband (eMBB) communication technology, as compared to the conventional radio access technology (RAT), is being proposed. In addition, not only massive machine type communications (massive MTC), which provide a variety of services anytime and anywhere by connecting multiple devices and objects, but also a communication system considering a service/user equipment (UE) sensitive to reliability and latency is being proposed. Various technical configurations for this are being proposed.

### SUMMARY

The present disclosure may provide a method and device for performing authentication of a user equipment (UE) in a wireless communication system.

The present disclosure may provide a method and device for performing authentication for a remote UE that performs communication with a core network through a relay UE based on a UE-to-network relay in a wireless communication system.

The present disclosure may provide a method and device for performing authentication for a remote UE through a control plane scheme or a user plane scheme in a wireless communication system.

The present disclosure may provide a method and device for performing authentication for a remote UE based on a service provided in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

As an example of the present disclosure, a user equipment (UE) authentication method in a wireless communication system may include being provided with, by a first UE, authentication scheme information, wherein a second UE relaying the first UE is also provided with the authentication scheme information, requesting, by the first UE, necessary information for direct discovery between UEs based on the authentication scheme information, receiving, by the first UE, the necessary information for direct discovery between UEs, and performing connection to a network and authentication through the second UE based on the received necessary information for direct discovery between UEs.

In addition, as an example, a first user equipment (UE) operating in a wireless communication system may include at least one transceiver, at least one processor, and at least one memory coupled operably with the at least one processor and storing instructions that instruct, when executed, the at least one processor to perform a specific operation, and the specific operation may control the transceiver to be provided with authentication scheme information, wherein a second UE relaying the first UE is also provided with the authentication scheme information, control the transceiver to request necessary information for direct discovery between UEs based on the authentication scheme information, control the transceiver to receive the necessary information for direct discovery between UEs, and perform connection to network and authentication through the second UE based on the received necessary information for direct discovery between UEs.

In addition, as an example of the present disclosure, a user equipment (UE) authentication method in a wireless communication system may include being provided with, by a first UE, authentication scheme information, wherein a second UE relayed by the first UE is also provided with the authentication scheme information, requesting, by the first UE, necessary information for direct discovery between UEs based on the authentication scheme information, receiving, by the first UE, the necessary information for direct discovery between UEs, and relaying network connection and authentication of the first UE based on the received necessary information for direct discovery between UEs.

In addition, as an example of the present disclosure, a first user equipment (UE) operating in a wireless communication system may include at least one transceiver, at least one processor, and at least one memory coupled operably with the at least one processor and storing instructions that instruct, when executed, the at least one processor to perform a specific operation, and the specific operation may control the transceiver to be provided with authentication scheme information, wherein a second UE relayed by the first UE is also provided with the authentication scheme information, control the transceiver to request necessary information for direct discovery between UEs based on the authentication scheme information, control the transceiver to receive the necessary information for direct discovery between UEs, and relay network connection and authentication of the first UE based on the received necessary information for direct discovery between UEs.

In addition, as an example of the present disclosure, a device including at least one memory and at least one processor coupled functionally with the at least one memory, and the at least one processor may control the device to be provided with authentication scheme information, wherein another device relaying the device is also provided with the authentication scheme information, to request necessary information for direct discovery between UEs based on the authentication scheme information, to receive the necessary information for direct discovery between UEs, and to perform connection to a network and authentication through the another device based on the received necessary information for direct discovery between UEs.

In addition, as an example of the present disclosure, a non-transitory computer-readable medium storing at least one instruction, including the at least one instruction that is executable by a processor, and the at least one instruction may control a device to be provided with authentication scheme information, wherein another device relaying the device is also provided with the authentication scheme information, to request necessary information for direct discovery between UEs based on the authentication scheme information, to receive the necessary information for direct discovery between UEs, and to perform connection to a network and authentication through the another device based on the received necessary information for direct discovery between UEs.

In addition, the following may commonly apply.

As an example of the present disclosure, a first UE may be a UE that supports connection to a network by performing mutual authentication with the network through a second UE based on a proximity-based service (ProSe) UE-to-network relay service.

In addition, as an example of the present disclosure, authentication scheme information may include a relay service code based on the Prose UE-to-network relay service.

In addition, as an example of the present disclosure, in case the first UE performs connection to a network and authentication through the second UE, an authentication scheme may be determined based on a first indicator.

In addition, as an example of the present disclosure, in case the authentication scheme information includes the first indicator, the connection to a network and authentication may be performed through the second UE based on a first authentication scheme, and in case the authentication scheme information does not include the first indicator, the connection to a network and authentication may be performed through the second UE based on a second authentication scheme.

In addition, as an example of the present disclosure, the authentication scheme information may include the first indicator, and in case the first indicator indicates the first authentication scheme, the connection to a network and authentication may be performed through the second UE based on the first authentication scheme, and in case the first indicator indicates the second authentication scheme, the connection to a network and authentication may be performed through the second UE based on the second authentication scheme.

In addition, as an example of the present disclosure, in case the first UE performs the connection to a network and authentication through the second UE, when the authentication scheme information includes ProSe key management function (PKMF) address information, the connection to a network and authentication may be performed through the second UE based on the first authentication scheme, and when the authentication scheme information does not include the PKMF address information, the connection to a network and authentication may be performed through the second UE based on the second authentication scheme.

In addition, as an example of the present disclosure, in case the connection to a network and authentication are performed through the second UE based on the first authentication scheme, necessary information for direct discovery between UEs may include the PKMF address information for performing authentication, the first UE may request and receive a security key from a PKMF corresponding to the PKMF address information and perform the connection to a network and authentication through the second UE based on the received security key.

In addition, as an example of the present disclosure, a request message of the first UE for requesting the security key to the PKMF may include identification information of the first UE.

In addition, as an example of the present disclosure, the first UE may transmit a direct communication request message including security key-related information generated based on the security key to the second UE, and the second UE may transmit a key request message including the security key-related information to the PKMF and thus perform authentication for the first UE.

In addition, as an example of the present disclosure, in case the authentication scheme information includes default information as the PKMF address information, the authentication for the first UE is indicated to be performed based on the first authentication scheme.

In addition, as an example of the present disclosure, in case the PKMF address information is default information, the first UE may request the necessary information for direct discovery between UEs, which includes the default information, to a direct discovery name management function (DDNMF), and valid PKMF address information may be derived by the DDNMF and be delivered to the first UE.

In addition, as an example of the present disclosure, the first UE may request and receive a security key from a PKMF corresponding to the valid PKMF address information delivered from the DDNMF and perform the connection to a network and authentication through the second UE based on the received security key.

In addition, as an example of the present disclosure, in case the connection to a network and authentication are performed through the second UE based on the second authentication scheme, the necessary information for direct discovery between UEs may include discovery-related information, and the connection to a network and authentication may be performed through the second UE based on the discovery-related information.

In addition, as an example of the present disclosure, the first UE may generate a subscription concealed identifier (SUCI) through the identification information of the first UE based on the discovery-related information and transmit a direct communication request message including the SUCI to the second UE.

In addition, as an example of the present disclosure, the second UE may transmit an NAS relay authentication request message including the SUCI to an access and mobility management function (AMF) of the second UE, and the AMF of the second UE may check whether a relay role of the second UE is authenticated and then perform the connection to a network and authentication by requesting authentication to an authentication server function (AUSF) of the first UE based on the SUCI.

The present disclosure may provide a method for performing authentication of a user equipment (UE) in a wireless communication system.

The present disclosure may provide a method for performing authentication for a remote UE that performs communication with a core network through a relay UE based on UE-to-network relay in a wireless communication system.

The present disclosure may perform an authentication scheme suitable for each service by performing authentication for a remote UE through a control plane scheme or a user plane scheme in a wireless communication system.

The present disclosure may perform efficient authentication by performing authentication for a remote UE based on a service provided in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### BRIEF DESCRIPTION OF THE DRAWINGS

The accompanying drawings are provided to aid understanding of the present disclosure, and embodiments of the present disclosure may be provided together with a detailed description. However, the technical features of the present disclosure are not limited to a specific drawing, and features disclosed in each drawing may be combined with each other to constitute a new embodiment. Reference numerals in each drawing may mean structural elements.

FIG. 1 is a view illustrating various reference points.

FIG. 2 is a view illustrating an example of a network structure of an evolved universal terrestrial radio access network (E-UTRAN) to which the present disclosure is applicable.

FIG. 3 is a view illustrating a general E-URTAN and an example of an architecture of an evolved packet core (EPC).

FIG. 4 is a view illustrating an example of a structure of a radio interface protocol in a control plane between user equipment (UE) and evolved node B (eNB).

FIG. 5 is a view illustrating an example of a structure of a radio interface protocol in a user plane between UE and eNB.

FIG. 6 is a view illustrating an example of an architecture of a general new radio (NR)-radio access network (RAN).

FIG. 7 is a view illustrating an example of functional separation of a general NG-RAN and a 5th generation core (5GC).

FIG. 8 is a view illustrating an example of a general architecture of a 5th generation (5G) system.

FIG. 9 is a view illustrating an example of a wireless device applicable to the present disclosure.

FIG. 10 is a view showing a method of performing ProSe direct discovery based on Model A that is applied in the present disclosure.

FIG. 11 is a view showing a method of performing ProSe direct discovery based on Model B that is applied in the present disclosure.

FIG. 12 is a view showing a method of performing ProSe communication based on a UE-to-network relay that is applied to the present disclosure.

FIG. 13 is a view showing a method of performing an authentication and security procedure based on primary authentication for a remote UE that uses a UE-to-network relay applied to the present disclosure.

FIG. 14 is a view showing a method of performing connection to a relay UE based on a security context of a remote UE applied to the present disclosure.

FIG. 15 is a view showing a method of deriving and allocating a key when authenticating a remote UE based on a control plane applied to the present disclosure.

FIG. 16 is a view showing a method of performing authentication for a remote UE based on a PKMF applied to the present disclosure.

FIG. 17 is a view showing a method of performing authentication between a remote UE applied to the present disclosure and a core network based on a control plane scheme.

FIG. 18 is a view showing a method of performing authentication between a remote UE applied to the present disclosure and a core network based on a user plane scheme.

FIG. 19 is a flowchart showing a method of performing authentication for a remote UE applied to the present disclosure.

### DETAILED DESCRIPTION

Following embodiments are achieved by combination of structural elements and features of the present disclosure in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present disclosure. The order of operations described in the embodiments of the present disclosure may be changed. Some structural elements or features of one embodiment may be included in another embodiment, or may be replaced with corresponding structural elements or features of another embodiment.

In the description of the drawings, procedures or steps which render the scope of the present disclosure unnecessarily ambiguous will be omitted and procedures or steps which can be understood by those skilled in the art will be omitted.

In the entire specification, when a certain portion “comprises” or “includes” a certain component, this indicates that the other components are not excluded, but may be further included unless specially described. The terms “unit”, “-or/er” and “module” described in the specification indicate a unit for processing at least one function or operation, which may be implemented by hardware, software and a combination thereof. In addition, “a or an”, “one” “the” and similar related words may be used as the sense of including both a singular representation and a plural representation unless it is indicated in the context describing the present specification (especially in the context of the following claims) to be different from this specification or is clearly contradicted by the context.

In this specification, the embodiments of the present disclosure are described with focus on the relationship of data reception and transmission between a base station and a mobile station. Herein, the base station means a terminal node of a network that performs direct communication with the mobile station. In this document, a specific operation, which is described to be performed by a base station, may be performed by an upper node of the base station in some cases.

That is, in a network consisting of a plurality of network nodes including abase station, various operations for communicating with a mobile station may be performed by the base station or network nodes other than the base station. Herein, “base station” may be replaced by such terms as “fixed station”, “Node B”, “eNode B(eNB)”, “gNode B(gNB)”, “ng-eNB”, “advanced base station(ABS)”, or “access point”.

Also, in the embodiments of the present disclosure, “terminal” may be replaced by such terms as “user equipment(UE)”, “mobile station(MS)”, “subscriber station(SS)”, “mobile subscriber station(MSS)”, “mobile terminal” or “advanced mobile station(AMS)”.

In addition, a transmission end refers to a fixed and/or mobile node that provides a data service or a voice service, and a reception end means a fixed and/or mobile node that receives a data service or a voice service. Accordingly, in the case of an uplink, a mobile station may be a transmission end, and a base station may be a reception end. Likewise, in the case of a downlink, a mobile station may be a reception end, and a base station may be a transmission end.

The embodiments of the present disclosure may be supported by standard documents disclosed in at least one of the following radio access systems: an IEEE 802 xx system, a 3rd generation partnership project (3GPP) system, a 3GPP long term evolution (LTE) system, a 3GPP 5th generation (5G) new radio (NR) system and a 3GPP2 system, and in particular, the embodiments of the present disclosure may be supported by the following documents: 3GPP TS (technical specification) 38.211, 3GPP TS 38.212, 3GPP TS 38.213, 3GPP TS 38.321, and 3GPP TS 38.331.

In addition, the embodiments of the present disclosure are applicable to another radio access system but is not limited to the above-described system. As an example, they are applicable to a system applied after a 3GPP 5G NR system and are not limited to a specific system.

That is, obvious steps and parts not described in the embodiments of the present disclosure may be described with reference to the above documents. In addition, all the terms disclosed in this document may be explained by the standard document.

Hereinafter, a preferred embodiment according to the present disclosure will be described in detail with reference to accompanying drawings. Detailed descriptions disclosed below together with accompanying drawings are intended to describe example embodiments of the present disclosure and not intended to show any sole embodiment in which a technical configuration of the present disclosure can be implemented.

In addition, specific terms used in the embodiments of the present disclosure are provided to help understand the present disclosure, and such specific terms may be used in any other modified forms without departing from the technical idea of the present disclosure.

The following technology may be applied to various radio access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA) and the like.

For clarity of explanation, the descriptions below are based on a 3GPP communication system (e.g. LTE, NR and the like), but the technical idea of the present disclosure is not limited thereto. LTE may mean a technology after 3GPP TS 36.xxx Release 8. Specifically, the LTE technology after 3GPP TS 36.xxx Release 10 may be referred to as LTE-A, and the one after 3GPP TS 36.xxx Release 13 may be referred to as LTE-A pro. 3GPP NR may mean a technology after TS 38.xxx Release 15. 3GPP 6G may mean a technology after TS Release 17 and/or Release 18. “xxx’ means the specific number of a standard document. LTE/NR/6G may be referred to collectively as 3GPP system.

Contents described in standard documents released earlier than the present disclosure may be referred to for the background art, terms and abbreviations used in the present disclosure. As an example, 36.xxx and 38.xxx standard documents may be referred to.

For terms, abbreviations, and other background descriptions that may be used in this document, the reader is referred to the following standards documents published prior to this document. In particular, for LTE/EPS (Evolved Packet System) terms, acronyms, and other background, see the 36.xxx series, 23.xxx series, and 24.xxx series, and for NR (new radio)/5GS terms, acronyms, and other background, see the 38.xxx series, 23.xxx series, and 24.xxx series.

### 3GPP LTE/EPS

3GPP TS 36.211: Physical channels and modulation
3GPP TS 36.212: Multiplexing and channel coding
3GPP TS 36.213: Physical layer procedures
3GPP TS 36.214: Physical layer; Measurements
3GPP TS 36.300: Overall description
3GPP TS 36.304: User Equipment (UE) procedures in idle mode
3GPP TS 36.306: User Equipment (UE) radio access capabilities
3GPP TS 36.314: Layer 2—Measurements
3GPP TS 36.321: Medium Access Control (MAC) protocol
3GPP TS 36.322: Radio Link Control (RLC) protocol
3GPP TS 36.323: Packet Data Convergence Protocol (PDCP)
3GPP TS 36.331: Radio Resource Control (RRC) protocol
3GPP TS 36.413: S1 Application Protocol (S1AP)
3GPP TS 36.423: X2 Application Protocol (X2AP)
3GPPP TS 22.125: Unmanned Aerial System support in 3GPP; Stage 1
3GPP TS 23.303: Proximity-based services (Prose); Stage 2
3GPP TS 23.401: General Packet Radio Service (GPRS) enhancements for Evolved Universal Terrestrial Radio Access Network (E-UTRAN) access
3GPP TS 23.402: Architecture enhancements for non-3GPP accesses
3GPP TS 23.286: Application layer support for V2X services; Functional architecture and information flows
3GPP TS 24.301: Non-Access-Stratum (NAS) protocol for Evolved Packet System (EPS); Stage 3
3GPP TS 24.302: Access to the 3GPP Evolved Packet Core (EPC) via non-3GPP access networks; Stage 3
3GPP TS 24.334: Proximity-services (ProSe) User Equipment (UE) to ProSe function protocol aspects; Stage 3
3GPP TS 24.386: User Equipment (UE) to V2X control function; protocol aspects; Stage 3

### 3GPP NR/5GS

3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: NR and NG-RAN Overall Description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description
3GPP TS 23.501: System Architecture for the 5G System
3GPP TS 23.502: Procedures for the 5G System
3GPP TS 23.503: Policy and Charging Control Framework for the 5G System; Stage 2
3GPP TS 24.501: Non-Access-Stratum (NAS) protocol for 5G System (5GS); Stage 3
3GPP TS 24.502: Access to the 3GPP 5G Core Network (5GCN) via non-3GPP access networks
3GPP TS 24.526: User Equipment (UE) policies for 5G System (5GS); Stage 3

### 3GPP V2X

3GPP TS 23.285: Architecture enhancements for V2X services
3GPP TR 23.786: Evolved Packet System (EPS) and the 5G System (5GS) to support advanced V2X services
3GPP TS 23.287: Architecture enhancements for 5G System (5GS) to support Vehicle-to-Everything (V2X) services
3GPP TS 24.587: Vehicle-to-Everything (V2X) services in 5G System (5GS); Protocol aspects; Stage 3
3GPP TS 24.588: Vehicle-to-Everything (V2X) services in 5G System (5GS); User Equipment (UE) policies; Stage 3

Hereinafter, the present disclosure is described based on the terms defined as above.

Three major requirement areas of 5G include (1) an enhanced mobile broadband (eMBB) area, (2) a massive machine type communication (mMTC) area, and (3) an ultra-reliable and low latency communications (URLLC) area.

Some use cases may require multiple areas for optimization, and other use case may be focused on only one key performance indicator (KPI). 5G supports these various use cases in a flexible and reliable method.

5G System Architecture to which the Present Disclosure is Applicable

A 5G system is an advanced technology from 4G LTE mobile communication technology and supports a new radio access technology (RAT), extended long term evolution (eLTE) as an extended technology of LTE, non-3GPP access (e.g., wireless local area network (WLAN) access), etc. through the evolution of the existing mobile communication network structure or a clean-state structure.

The 5G system is defined based on a service, and an interaction between network functions (NFs) in an architecture for the 5G system can be represented in two ways as follows.
Reference point representation: indicates an interaction between NF services in NFs described by a point-to-point reference point (e.g., N11) between two NFs (e.g., AMF and SMF).
Service-based representation: network functions (e.g., AMF) within a control plane (CP) allow other authenticated network functions to access its services. The representation also includes a point-to-point reference point, if necessary.

### Overview of 3GPP System

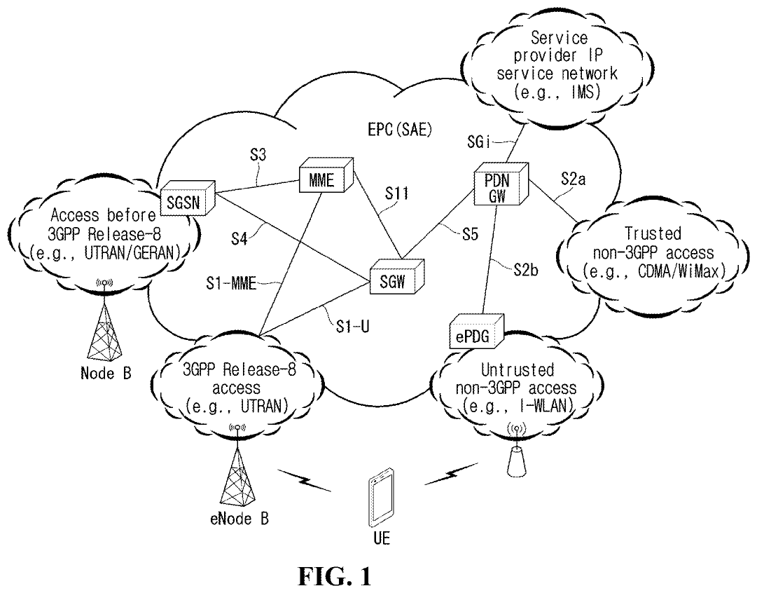

FIG. 1 illustrates various reference points.

In the example of a network structure of FIG. 1, a LET/EPS-based network structure is disclosed, which may operate with reference to what is specified in the above-described standard document released before this document. In the network structure of FIG. 1, at least one of the entities SGW, PDN, GW, MME, SGSN and ePDG may operate with reference to what is specified in the above-described standard document released before this document. In addition, S1-MME, S1-U, S2a, S2b, S3, S4, S5, S11 and SGi may exist as interfaces between each entity, which may refer to what is specified in the above-described standard document released before this document. In addition, another entity and another interface may be configured with reference to what is specified in the above-described standard document released before this document, but are not limited to a specific form.

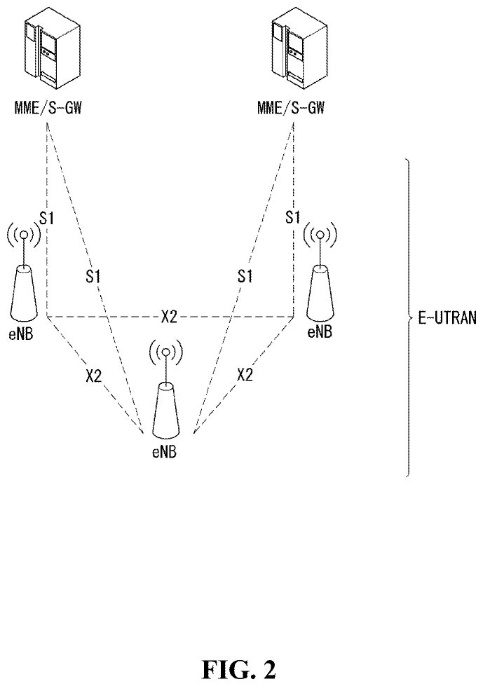

FIG. 2 illustrates an example of a network structure of an evolved universal terrestrial radio access network (E-UTRAN) to which the present disclosure is applicable.

An E-UTRAN system is an evolved version of the existing UTRAN system and may be, for example, 3GPP LTE/LTE-A system. Communication networks are widely deployed to provide various communication services such as voice (e.g., voice over Internet protocol (VoIP)) through IMS and packet data.

Referring to FIG. 2, an E-UMTS network includes an E-UTRAN, an EPC, and one or more UEs. The E-UTRAN consists of eNBs that provide control plane and user plane protocols to the UE, and the eNBs are interconnected with each other by means of the X2 interface, and matters disclosed in standard documents published prior to this document as mentioned above can be referred to.

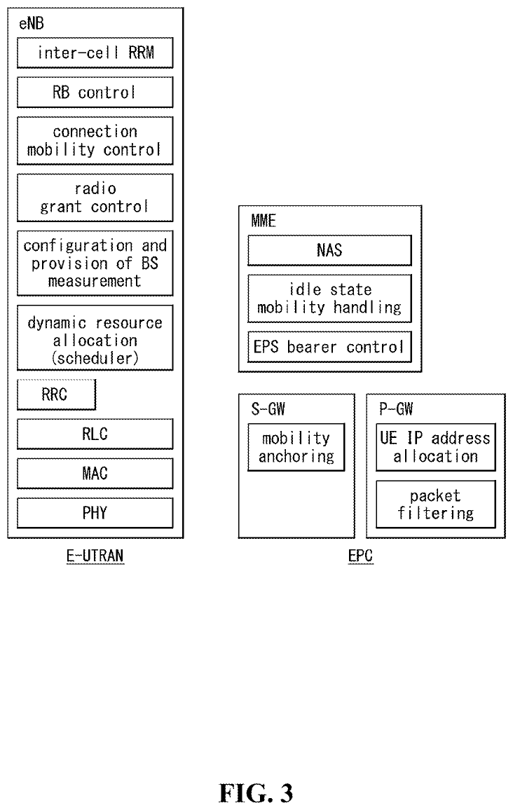

FIG. 3 is a view illustrating a general E-URTAN and an example of an architecture of an evolved packet core (EPC).

As illustrated in FIG. 3, the eNB can perform functions such as routing to gateway while radio resource control (RRC) connection is activated, scheduling and transmission of paging messages, scheduling and transmission of a broadcast channel (BCH), dynamic allocation of resources in uplink and downlink to the UE, configuration and provision for the measurement of the eNB, radio bearer control, radio admission control, and connection mobility control. The eNB can perform functions such as paging situation in the EPC, management of an LTE IDLE state, ciphering of a user plane, SAE bearer control, and ciphering and integrity protection of NAS signaling.

Annex J of 3GPP TR 23.799 shows various architectures by combining 5G and 4G. An architecture using NR and NGC is disclosed in 3GPP TS 23.501.

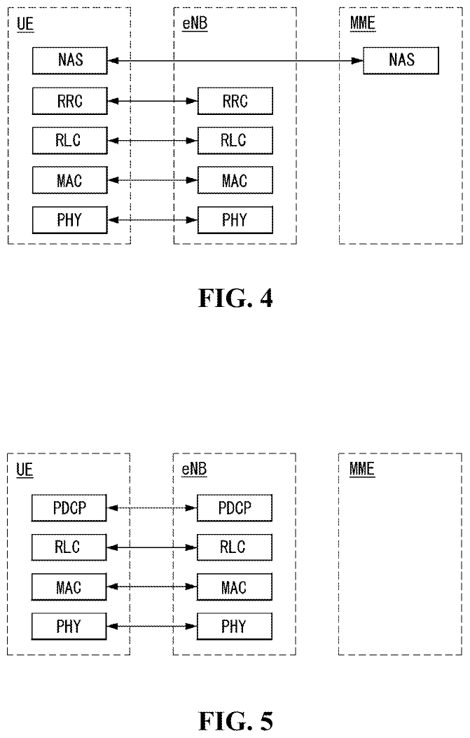

FIG. 4 is a view illustrating an example of a structure of a radio interface protocol in a control plane between user equipment (UE) and evolved node B (eNB), and FIG. 5 is view illustrating an example of a structure of a radio interface protocol in a user plane between UE and eNB.

The radio interface protocol is based on 3GPP radio access network standard. The radio interface protocol horizontally consists of a physical layer, a data link layer, and a network layer, and is vertically divided into a user plane for data information transmission and a control plane for control signaling delivery.

The protocol layers may be divided into L1 (first layer), L2 (second layer), and L3 (third layer) based upon three lower layers of an open system interconnection (OSI) standard model that is well known in the art of communication systems, and matters disclosed in standard documents published prior to this document as mentioned above can be referred to.

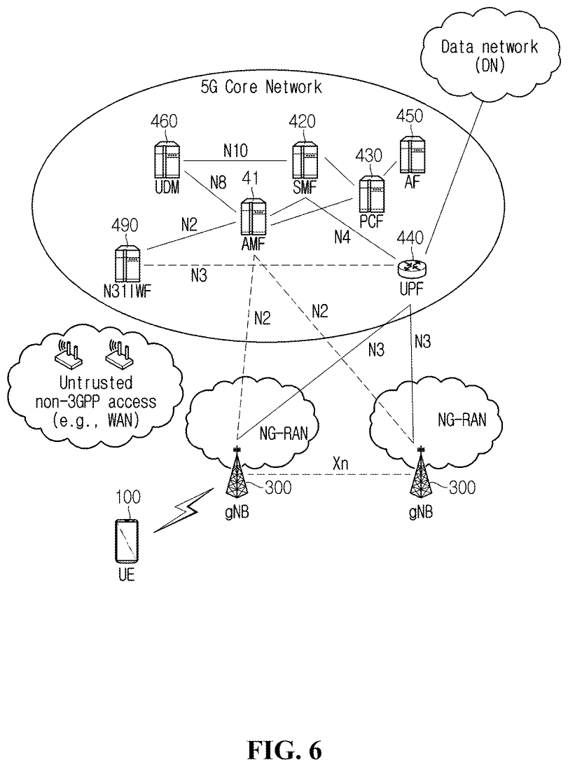

FIG. 6 is a view showing an example of a wireless communication system applied to the present disclosure.

A 5G core (5GC) may include various components, some of which are included in FIG. 6 such as an access and mobility management function (AMF) 410, a session management function (SMF) 420, a policy control function (PCF) 430, a user plane function (UPF) 440, an application function (AF) 450, unified data management (UDM) 460, and a non-3GPP interworking function (N3IWF) 490.

A UE 100 is connected to a data network via the UPF 440 through a next generation radio access network (NG-RAN) including gNB 300. The UE 100 may be provided with a data service through an untrusted non-3GPP access, for example, a wireless local area network (WLAN). In order to connect the non-3GPP access to a core network, the N3IWF 490 may be placed.

The N3IWF 490 serves to manage interworking between non-3GPP access and a 5G system. In case the UE 100 is connected with a non-3GPP access (e.g. WiFi referred to as IEEE 802.11), the UE 100 may be connected to a 5G system through the N3IWF 490. The N3IWF 490 performs control signaling with the AMF 410 and is connected to the UPF 440 through a N3 interface for data transmission.

The AMF 410 may manage access and mobility in a 5G system. The AMF 410 may serve to manage non-access stratum (NAS) security. The AMF 410 may serve to handle mobility in idle state.

The UPF 440 serves as a gateway for transmitting and receiving data of a user. The UPF node 440 may perform all or some of the user plane functions of a serving gateway (S-GW) and a packet data network gateway (P-GW) of the 4G mobile communication.

The UPF 440 is a component that operates as a boundary point between a next generation RAN (NG-RAN) and a core network and maintains a data path between the gNB 300 and the SMF 420. In addition, in case the UE 100 moves across a region served by the gNB 300, the UPF 440 serves as a mobility anchor point. The UPF 440 may serve to handle a PDU. For mobility within a NG-RAN (e.g. a NG-RAN defined after 3GPP Release-15), the UPF 440 may route packets. In addition, the UPF 440 may function as an anchor point for mobility with another 3GPP network (e.g. a RAN defined before 3GPP Release-15), for example, a universal mobile telecommunications system (UMTS) terrestrial radio access network (UTRAN), an evolved-UTRAN (E-UTRAN), or a global system for mobile communication (GSM)/enhanced data rates for global evolution (EDGE) radio access network (GERAN). The UPF 440 may correspond to a termination point of a data interface towards a data network.

The PCF 430 is a node that controls a policy of a service provider. The AF 450 is a server for providing various services to the UE 100. The UDM 460 is a server that manages information on subscribers, like a home subscriber server (HSS) of 4G mobile communication. The UDM 460 stores and manages the information on subscribers in a unified data repository (UDR).

The SMF 420 may serve to allocate an Internet protocol (IP) address of the UE 100. In addition, the SMF 420 may control a protocol data unit (PDU) session.

Hereinafter, for convenience of explanation, the reference numerals for AMF 410, SMF 420, PCF 430, UPF 440, AF 450, UDM 460, N3IWF 490, gNB 300, or UE 100 may be omitted, and those may operate with reference to what is specified in a standard document released before this document.

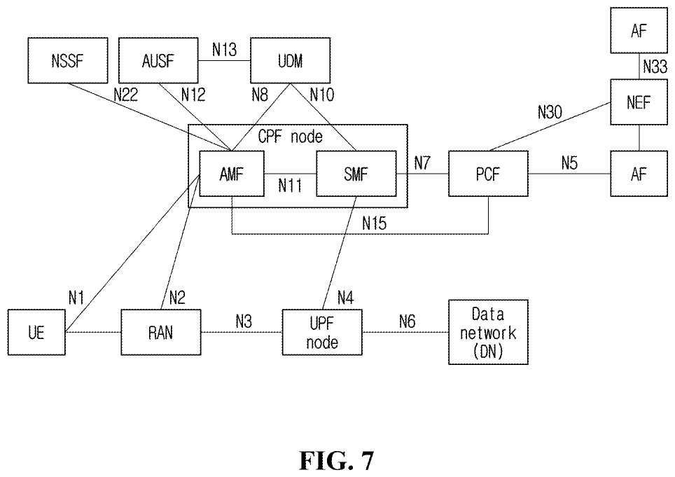

FIG. 7 is a view showing an example of a structure of a wireless communication system represented from a perspective of a node, as applied to the present disclosure.

Referring to FIG. 7, a UE is connected with a data network (DN) through a NG-RAN. A control plane function (CPF) node performs all or some of the functions of a mobility management entity (MME) of 4G mobile communication and all or some of the control plane functions of a serving gateway (S-GW) and a PDN gateway (P-GW). The CPF node includes an AMF and an SMF.

A UPF node serves as a gateway where data of a user is transmitted and received.

An authentication server function (AUSF) authenticates and manages the UE. A network slice selection function (NSSF) is a node for network slicing, as described below.

A network exposure function (NEF) provides a mechanism for safely exposing a service of 5G core and its function.

Reference points shown in FIG. 7 are as follows. N1 denotes a reference point between N1 and UE. N2 denotes a reference point between (R)AN and AMF. N3 denotes a reference point between (R)AN and UPF. N4 denotes a reference point between SMF and UPF. N5 denotes a reference point between PCF and AF. N6 denotes a reference point between UPF and DN. N7 denotes a reference point between SMF and PCF. N8 denotes a reference point between UDM and AMF. N9 denotes a reference point between UPFs. N10 denotes a reference point between UDM and SMF. N11 denotes a reference point between AMF and SMF. N12 denotes a reference point between AMF and AUSF. N13 denotes a reference point between UDM and AUSF. N14 denotes a reference point between AMFs. N15 denotes a reference point between PCF and AMF in non-roaming scenario and a reference point between AMF and PCF of a visited network in roaming scenario. N16 denotes a reference point between SMFs. N22 denotes a reference point between AMF and NSSF. N30 denotes a reference point between PCF and NEF. N33 may denote a reference point between AF and NEF, and the above-described entities and interfaces may be configured with reference to what is specified in a standard document released before this document.

A radio interface protocol is based on a 3GPP radio access network. The radio interface protocol horizontally consists of a physical layer, a data link layer, and a network layer and is vertically divided into a user plane for data information transmission and a control plane for control signaling.

Protocol layers may be divided into layer-1 (L1), layer-2 (L2), and layer-3 (L3) based on three sub-layers of an open system interconnection (OSI) reference model that is widely known in a communication system.

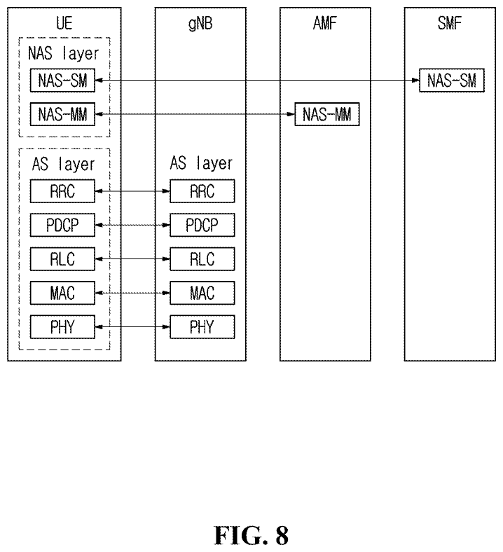

Hereinafter, the present disclosure will describe each layer of a radio protocol. FIG. 8 is a view showing an example of a structure of a radio interface protocol between a UE and a gNB.

Referring to FIG. 8, an access stratum (AS) layer may include a physical (PHY) layer, a medium access control layer, a radio link control (RLC) layer, a packet data convergence protocol (PDCP) layer, and a radio resource control (RRC) layer, and an operation based on each layer may be performed with reference to what is specified in a standard document released before this document.

### Communication System Applicable to the Present Disclosure

Although not limited thereto, various descriptions, functions, procedures, proposals, methods and/or operation flowcharts disclosed in the present disclosure are applicable to various fields requiring wireless communication/connection (e.g., 5G) between devices.

Hereinafter, it will be described in greater detail with reference to the drawings. In the following drawings/description, the same reference numerals may denote the same or corresponding hardware blocks, software blocks or functional blocks unless otherwise stated.

### Wireless Device Applicable to the Present Disclosure

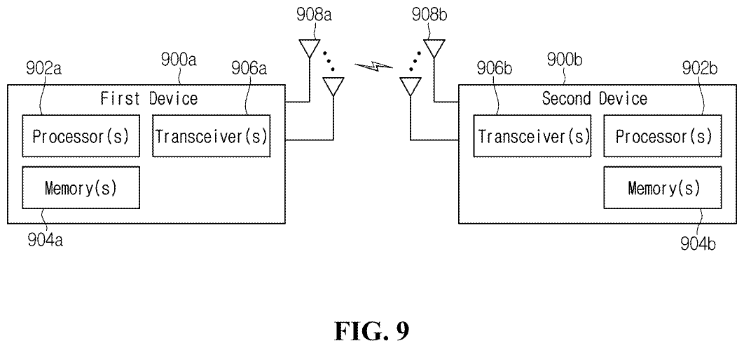

FIG. 9 is a view illustrating an example of a wireless device applicable to the present disclosure.

Referring to FIG. 9, a first wireless device 900a and a second wireless device 900b may transmit and receive radio signals through various radio access technologies (e.g., LTE, NR). Herein, the first wireless device 900a and the second wireless device 900b may correspond to (the wireless device 100x, the base station 120) and/or (the wireless device 100x, the base station 100x) of FIG. 1.

The first wireless device 900a may include at least one processor 902a and at least one memory 904a and further include at least one transceiver 906a and/or at least one antenna 908a. The processor 902a may be configured to control the memory 904a and/or the transceiver 906a and to implement descriptions, functions, procedures, proposals, methods and/or operational flowcharts disclosed in this document. For example, the processor 902a may process information in the memory 904a, generate first information/signal, and then transmit a wireless signal including the first information/signal through the transceiver 906a. In addition, the processor 902a may receive a wireless signal including second information/signal through the transceiver 906a and then store information obtained from signal processing of the second information/signal in the memory 904a. The memory 904a may be coupled to the processor 902a and store various types of information associated with the operation of the processor 902a.

The second wireless device 900b may include at least one processor 902b and at least one memory 904b and further include at least one transceiver 906b and/or at least one antenna 908b. The processor 902b may be configured to control the memory 904b and/or the transceiver 906b and to implement descriptions, functions, procedures, proposals, methods and/or operational flowcharts disclosed in this document. For example, the processor 902b may process information in the memory 904b, generate third information/signal, and then transmit a wireless signal including the third information/signal through the transceiver 906b. In addition, the processor 902b may receive a wireless signal including fourth information/signal through the transceiver 906b and then store information obtained from signal processing of the fourth information/signal in the memory 904b. The memory 904b may be coupled to the processor 902b and store various types of information associated with the operation of the processor 902b. For example, the memory 904b may perform some or all of the processes controlled by the processor 902b or store software codes including instructions for implementing descriptions, functions, procedures, proposals, methods and/or operational flowcharts disclosed in this document. Herein, the processor 902b and the memory 904b may be a part of a communication modem/circuit/chip designed for implementing a radio communication technology (e.g., LTE, NR). The transceiver 906b may be coupled to the processor 902b and transmit and/or receive a wireless signal through at least one antenna 908b. The transceiver 906b may include a transmitter and/or a receiver. The transceiver 906b is interchangeable with a RF unit. In the present disclosure, a wireless device may also mean a communication modem/circuit/chip.

In addition, a wireless device structure applicable to the present disclosure is not limited to FIG. 9 but may be configured in various forms. Particularly, the present disclosure may apply to any wireless device that performs an operation of transmitting and/or receiving a radio signal, but is not limited to a specific form.

As an example, a ProSe direct discovery, which is a function supported based on a ProSe service, may be a process where a UE discovers and recognizes another UE adjacent thereto based on NR, E-UTRA or WLAN. Herein, the ProSe direct discovery may have two types, that is, an open type and a restricted type. As an example, the open type may be a type of performing a direct discovery without explicit permission for a discovered UE. On the other hand, the restricted type may be a type of performing a direct discovery only when there is explicit permission for a discovered UE.

As an example, the ProSe direct discovery may be a service that is provided alone to use information on a specific application of a discovered UE. A UE may perform an additional operation through information obtained based on the ProSe direct discovery, and thus a service may be provided. In addition, as an example, non-Public Safety UEs with a ProSe function, which have authority over the ProSe direct discovery, may perform the ProSe direct discovery based on NR or E-UTRA in a serving PLMN. Herein, as an example, in case a non-Public Safety UE has lost NR or E-UTRA coverage, the non-Public Safety UE may not support the ProSe direct discovery function but may not be limited thereto.

In addition, as an example, the ProSe direct discovery may operate based on Model A or Model B but may not be limited thereto. As an example, in Model A, a UE with a ProSe function being enabled may perform a role of at least one of an announcing UE and a monitoring UE. As an example, the announcing UE may be a UE that announces specific information available in another UE adjacent thereto for which discovery is permitted. The monitoring UE may be a UE that monitors the specific information announced by the announcing UE. Herein, the announcing UE may broadcast a discovery message during a preset discovery section, and the monitoring UE may operate by checking a message of interest among broadcast messages and proceeding to a subsequent process. That is, Model A may be a model where an announcing UE itself delivers its presence and associated information to neighbor UEs through broadcast and discovery is performed when a neighbor monitoring UE is interested in the information.

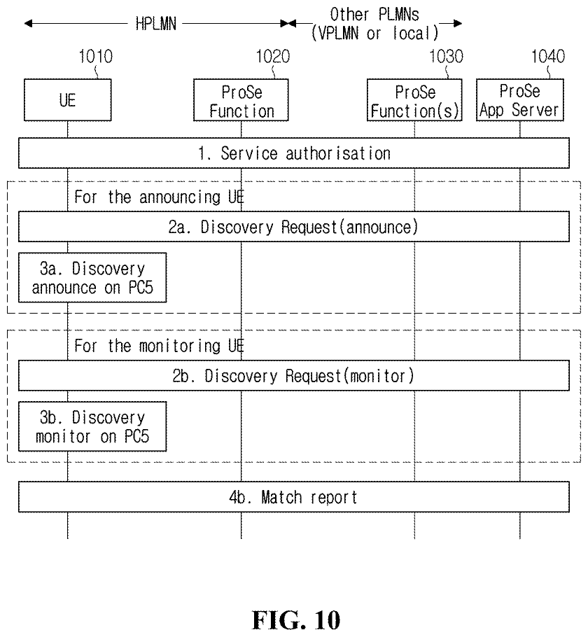

As a concrete example, FIG. 10 is a view showing a method of performing ProSe direct discovery based on Model A that is applied in the present disclosure. Referring to FIG. 10, a UE 1010 may perform service authentication based on ProSe functions 1020 and 1030 and a ProSe App server 1040. Next, as an announcing UE, the UE 1010 may transmit a discovery request message to the ProSe function 1020 and then perform service authentication through the ProSe App server 1040. Next, when completing the authentication, the UE 1010 may perform announcing in a broadcasting way. In addition, in case the UE 1010 performs monitoring, the UE 1010 as a monitoring UE may transmit a discovery request message to the ProSe function 1020 and then perform service authentication through the ProSe App SERVER 1040. Next, the UE 1010 may monitor an announced message. The UE 1010 may perform service matching based on announcing message monitoring and report matching information to the ProSe function 1020 and the ProSe App server 1040.

On the other hand, Model B as the restricted discovery type may be a model where a discoverer UE transmits a restricted discovery message to a discoveree UE and ProSe direct discovery is performed. Specifically, the discoverer UE may transmit a request including specific information to be discovered to the discoveree UE. Herein, the discoveree UE may deliver a response message including relevant information based on the request message received from the discoverer UE to the discoverer UE. That is, in Model B, the discoverer UE may transmit a discovery request message for specific information to a specific discoveree UE and receive a response thereto, so that ProSe direct discovery may be performed. As an example, a Public Safety discovery is a restricted discovery, and a monitoring UE of the above-described Model A and a discovering UE of the above-described Model B may need authorization to perform discovery in relation to a specific service and thus perform ProSe direct discovery.

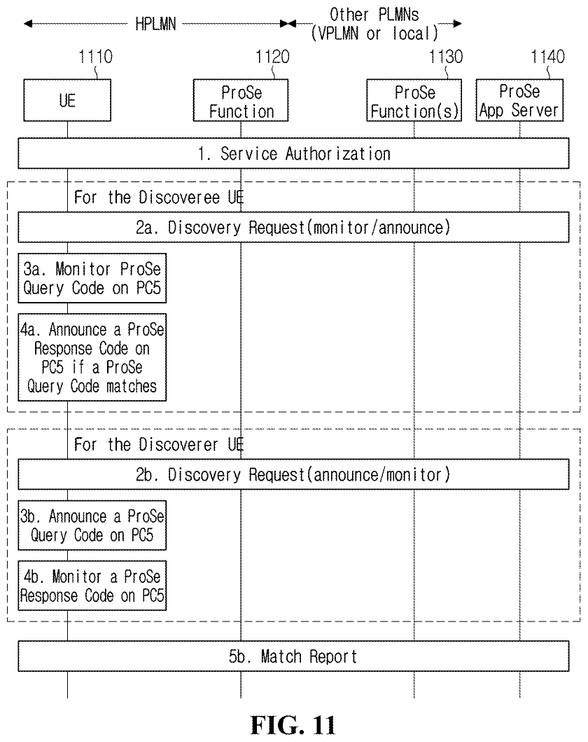

As a concrete example, FIG. 11 is a view showing a method of performing ProSe direct discovery based on Model B that is applied in the present disclosure. Referring to FIG. 11, a UE 1110 may perform service authentication based on ProSe functions 1120 and 1130 and a ProSe App server 1040. Next, as a discoveree UE, the UE 1110 may transmit a discovery request message to the ProSe function 1120 and then perform the service authentication through the ProSe App server 1140. Herein, as the discoveree UE, the UE 1110 may obtain a ProSe response code and a discovery query filter. As the discoveree UE, the UE 1110 may monitor a ProSe query code through PC5, and when the ProSe query code is matched, the UE 1110 may announce the ProSe response code through PC5. In addition, as a discoverer UE, the UE 1110 may transmit a discovery request message to the ProSe function 1120 and then perform service authentication through the ProSe App server 1140. Herein, as the discoverer UE, the UE 1110 may obtain a discovery response filter consisting of a ProSe query code and a ProSe response code and a ProSe App mask. Next, as the discoverer UE, the UE 1110 may announce the ProSe query code, monitor the ProSe response code transmitted from the discoveree UE through PC5, thereby completing discovery and performing matching for a corresponding service. Next, matching information may be reported to the ProSe function 1120 and the ProSe App server 1140.

Based on what is described above, direct communication may be performed. In addition, as an example, a core network of anew communication system (e.g. 5G) may support at least one of ProSe direct discovery, ProSe direct communication, and ProSe UE-to-network relay. Herein, UEs operating based on a ProSe function may perform authentication. In addition, as an example, in UEs operating based on a ProSe function, pre-provisioning may be performed for ProSe direct discovery, ProSe direct communication and ProSe UE-to-network relay, and thus the above-described service may be provided.

Hereinafter will be described a method for performing authentication for the ProSe UE-to-network relay service among the above-described ProSe service and performing pre-provisioning. As an example, authentication and provisioning for 5G ProSe UE-to-network relay may be performed with reference to a parameter and a policy in Table 1 below but may not be limited thereto. In addition, a principle of applying a parameter for the ProSe UE-to-network relay based on Table 1 described above may refer to Table 2 and Table 3 below but may not be limited thereto.

TABLE 1
5.1.4.1 Policy/Parameter provisioning for 5G ProSe UE-to-Network Relay
The following information is provisioned in the UE in support of the UE assuming the role of
a ProSe UE-to-Network Relay:
1) Authorisation policy for acting as a 5G ProSe Layer-3 and/or Layer-2 UE-to-Network Relay
when “served by NG-RAN”:
- PLMNs in which the UE is authorized to relay traffic for 5G ProSe Layer-3 and/or Layer-2
Remote UEs.
2) ProSe Relay Discovery policy/parameters for 5G ProSe UE-to-Network Relay:
- Includes the parameters that enable the UE to perform 5G ProSe Relay Discovery when
provisioned from the PCF in the ME or configured in the UICC:
- 5G ProSe UE-to-Network Relay Discovery parameters (User Info ID, Relay Service Code(s));
- Default Destination Layer-2 ID(s) for sending and receiving initial signaling of discovery
messages;
- For Layer 3 ProSe UE-to-Network Relay, the PDU Session parameters (PDU Session type,
DNN, SSC Mode, S-NSSAI, Access Type Preference) to be used for the relayed traffic for each
ProSe Relay Service Code;
- Includes security related content for 5G ProSe Relay Discovery for each ProSe Relay Service
Code.
Editor's note: Whether the security parameters can be provided by the PCF and details of
security parameters will be determined by SA3 WG.
NOTE 1: 5G ProSe Relay Discovery policy/parameters can be provided from ProSe
Application Server to the 5G ProSe UE-to-Network Relay.
3) For Layer 3 ProSe UE-to-Network Relay, QoS mapping(s):
- Each QoS mapping entry includes:
- a mapping between a 5QI value and a PQI value;
- a PQI PDB adjustment factor, for the PC5 communication for the UE-to-Network Relay
operation;
- optional the Relay Service Code(s) associates with the QoS mapping entry.
4) For 5G ProSe Layer 3 UE-to-Network Relay to relay Ethernet or Unstructured traffic from
Remote UE by using IP type PDU Session,
- Mapping of ProSe Service(s) to ProSe Application Server address information (consisting of
IP address/FQDN and transport layer port number).
The following information is provisioned in the UE in support of the UE assuming the role of
a Remote UE and thereby enabling the use of a ProSe UE-to-Network Relay:
1) Authorisation policy for using a 5G ProSe Layer-3 and/or L ayer-2 UE-to-Network Relay:
- Indicates whether the UE is authorised to use a 5G ProSe Layer-3 and/or Layer-2 UE-to-
Network Relay.
2) Policy/parameters for 5G ProSe Relay Discovery:
- Includes the parameters for 5G ProSe Relay Discovery and for enabling the UE to connect to
the 5G ProSe UE-to-Network Relay after discovery when provisioned from the PCF in the ME
or configured in the UICC:
- ProSe UE-to-Network Relay Discovery parameters (User Info ID, Relay Service Code(s));
- Default Destination Layer-2 ID(s) for sending and receiving initial signaling of discovery
messages;
- For 5G ProSe Layer 3 UE-to-Network Relay, the PDU Session parameters (PDU Session
type, DNN, SSC Mode, S-NSSAI, Access Type Preference) to be used for the relayed traffic
for each ProSe Relay Service Code;
- Includes security related content for ProSe Relay Discovery for each ProSe Relay Service
Codes.
Editor's note: Whether the security parameters can be provided by the PCF and details of
security parameters will be determined by SA3 WG.
NOTE 2: ProSe Relay Discovery policy/parameters can be provided from ProSe Application
Server to the Remote UE.
The following information is provisioned in the UE in support of the UE assuming the role of
a 5G ProSe UE-to-Network Relay as well as in the UE in support of the UE assuming the role
of a 5G ProSe Remote UE and thereby enabling the use of a 5G ProSe UE-to-Network Relay:
1) Radio parameters for 5G ProSe Relay Discovery when the UE is not “served by NG-RAN
”:
- Includes the radio parameters NR PC5 with Geographical Area(s) and an indication of
whether they are “operator managed” or “non-operator managed”. The UE uses the radio
parameters to perform 5G ProSe Direct Discovery over PC5 reference point when “not served
by NG-RAN” only if the UE can reliably locate itself in the corresponding Geographical Area.
Otherwise, the UE is not authorized to transmit.
2) Radio parameters for 5G ProSe Relay Communication when the UE is not “served by NG-
RAN”:
- Includes the radio parameters NR PC5 with Geographical Area(s) and an indication of
whether they are “operator managed” or “non-operator managed”. The UE uses the radio
parameters to perform 5G ProSe Direct Communication over PC5 reference point when “not
served by NG-RAN” only if the UE can reliably locate itself in the corresponding Geographical
Area. Otherwise, the UE is not authorized to transmit.

TABLE 2
5.1.4.2 Principles for applying parameters for 5G ProSe UE-to-Network Relay
5.1.4.2.1 Principles for applying parameters for ProSe UE-to-Network Relay discovery
For 5G ProSe UE-to-Network Relay discovery over PC5 reference point, the operator may pre-
configure the UEs with the required provisioning parameters for 5G ProSe UE-to-Network Relay
discovery, without the need for the UEs to connect to the 5GC to get this initial configuration.
The following applies:
- The provisioning parameters for 5G ProSe UE-to-Network Relay discovery could be from
different sources and their priorities are described in clause 5.1.1.
- The ME provisioning parameters shall not be erased when a USIM is deselected or replaced.
The UE shall use radio resources for 5G ProSe UE-to-Network Relay discovery as follows:
- While a UE has a serving cell and is camped on a cell and the UE intends to use for 5G ProSe
UE-to-Network Relay discovery the radio resources (i.e. carrier frequency) operated by this cell,
then the UE shall use the radio resource description indicated by this cell the UE is camped on
and ignore any radio resource description of the same radio resource provisioned in the ME or
the UICC. If the cell does not provide radio resources for 5G ProSe UE-to-Network Relay
discovery, the UE shall not perform 5G ProSe UE-to-Network Relay discovery message
transmission and reception on radio resources operated by this cell;
- If the UE intends to use “operator-managed” radio resources (i.e. carrier frequency) for 5G ProSe
UE-to-Network Relay discovery that are not operated by the UE's serving cell, as specified in
clause 5.1.4.1, or if the UE is out of coverage, the UE shall search for a cell in any PLMN that is
operating the provisioned radio resources (i.e. carrier frequency) as defined in TS 38.300 [12] and
TS 38.304 [13]; and:
- If the UE finds such a cell in the registered PLMN or a PLMN equivalent to the registered
PLMN, and authorization for 5G ProSe UE-to-Network Relay discovery to this PLMN is
confirmed, the UE shall use the radio resource description indicated by that cell. If that cell does
not provide radio resources for 5G ProSe UE-to-Network Relay discovery, the UE shall not
perform 5G ProSe UE-to-Network Relay discovery message transmission and reception on those
radio resources;
- If the UE finds such a cell but not in the registered PLMN or a PLMN equivalent to the registered
PLMN, and that cell belongs to a PLMN authorized for 5G ProSe UE-to-Network Relay
discovery and provides radio resources for 5G ProSe UE-to-Network Relay discovery then the
UE shall perform PLMN selection triggered by 5G ProSe UE-to-Network Relay discovery as
defined in TS 23.122 [14];
- If the UE finds such cell but not in a PLMN authorized for 5G ProSe UE-to-Network Relay
discovery the UE shall not use 5G ProSe UE-to-Network Relay discovery;
- If the UE does not find any such cell in any PLMN, then the UE shall consider itself “not served
by NG-RAN” and use radio resources provisioned in the ME or the UICC. If no such provision
exists in the ME or the UICC or the provision does not authorize 5G ProSe UE-to-Network Relay
discovery, then the UE is not authorized to transmit;
- The UE is allowed to use “operator-managed” radio resources (i.e. carrier frequency)
provisioned in the ME or the UICC for 5G ProSe UE-to-Network Relay discovery if the UICC
indicates it is authorized;
- If the UE intends to use “non-operator-managed” radio resources (i.e. carrier frequency) for
ProSe UE-to-Network Relay discovery, according to TS 36.331 [15] or TS 38.331 [16] and as
specified in clause 5.1.4.1, then the UE shall perform 5G ProSe UE-to-Network Relay discovery
using resource provisioned in the ME or the UICC. If no such provision exists in the ME or the
UICC or the provision does not authorize 5G ProSe UE-to-Network Relay discovery, then the
UE is not authorized to transmit;
NOTE 1: It is possible for operators to configure UEs (e.g. Public Safety UEs) to use only
“operator-managed” radio resources (i.e. carrier frequency) for 5G ProSe UE-to-Network Relay
discovery when the UE is “not served by NG-RAN”.
- The UE provisioning shall support setting Geographical Areas;
NOTE 2: It is possible for a UE to use other radio resources for 5G ProSe UE-to-Network Relay
discovery based on the Geographical Area instead of those operated by the serving NG-RAN cell,
when provisioned in the UE, even if the UE's serving cell offers normal service and the SIBs for
NR sidelink communication defined in TS 38.331 [16] indicates that the service (5G ProSe UE-
to-Network Relay discovery) is available. This is to cover the scenario when e.g. the radio
resources used for 5G ProSe UE-to-Network Relay discovery are not owned by the serving
network of the UE.
NOTE 3: When cross-carrier operation is supported, according to TS 36.331 [15] or
TS 38.331 [16], a UE can be instructed by its serving cell to perform 5G ProSe UE-to-Network
Relay discovery over a different carrier frequency. The UE is still considered as “served by NG-
RAN” in this case.
NOTE 4: The scenario that a cell is detected and the cell does not provide support for 5G ProSe
UE-to-Network Relay discovery when the UE attempts to use a carrier frequency configured for
5G ProSe UE-to-Network Relay discovery, is considered a configuration error. Therefore, the UE
does not transmit on that frequency to avoid interference to the network.
- The 5G ProSe UE-to-Network Relay discovery is only specified for NR.
Editor's note: It is FFS whether and how to apply the mobility restriction for 5G ProSe UE-to-
Network relay or 5G ProSe remote UE.

TABLE 3
5.1.4.2.2 Principles for applying parameters for 5G ProSe UE-to-Network Relay communication
For 5G ProSe UE-to-Network Relay communication over PC5 reference point, the operator may
pre-configure the UEs with the required provisioning parameters for 5G ProSe UE-to-Network
Relay communication, without the need for the UEs to connect to the 5GC to get this initial
configuration. The following applies:
- The provisioning parameters for 5G ProSe UE-to-Network Relay communication could be from
different sources and their priorities are described in clause 5.1.1.
- The ME provisioning parameters shall not be erased when a USIM is deselected or replaced.
The UE shall use radio resources for 5G ProSe UE-to-Network Relay communication as follows:
- While a UE has a serving cell and is camped on a cell and the UE intends to use for 5G ProSe
UE-to-Network Relay communication the radio resources (i.e. carrier frequency) operated by this
cell, then the UE shall use the radio resource description indicated by this cell the UE is camped
on and ignore any radio resource description of the same radio resource provisioned in the ME or
the UICC. If the cell does not provide radio resources for 5G ProSe UE-to-Network Relay
communication, the UE shall not perform 5G ProSe UE-to-Network Relay communication
message transmission and reception on radio resources operated by this cell;
- If the UE intends to use “operator-managed” radio resources (i.e. carrier frequency) for 5G ProSe
UE-to-Network Relay communication that are not operated by the UE's serving cell, as specified
in clause 5.1.4.1, or if the UE is out of coverage, the UE shall search for a cell in any PLMN that
is operating the provisioned radio resources (i.e. carrier frequency) as defined in TS 38.300 [12]
and TS 38.304 [13]; and:
- If the UE finds such a cell in the registered PLMN or a PLMN equivalent to the registered
PLMN, and authorization for 5G ProSe UE-to-Network Relay communication to this PLMN is
confirmed, the UE shall use the radio resource description indicated by that cell. If that cell does
not provide radio resources for 5G ProSe UE-to-Network Relay communication, the UE shall not
perform 5G ProSe UE-to-Network Relay communication message transmission and reception on
those radio resources;
- If the UE finds such a cell but not in the registered PLMN or a PLMN equivalent to the registered
PLMN, and that cell belongs to a PLMN authorized for 5G ProSe UE-to-Network Relay
communication and provides radio resources for 5G ProSe UE-to-Network Relay communication
then the UE shall perform PLMN selection triggered by 5G ProSe UE-to-Network Relay
communication as defined in TS 23.122 [14];
- If the UE finds such cell but not in a PLMN authorized for 5G ProSe UE-to-Network Relay
communication the UE shall not use 5G ProSe UE-to-Network Relay communication;
- If the UE does not find any such cell in any PLMN, then the UE shall consider itself “not served
by NG-RAN” and use radio resources provisioned in the ME or the UICC. If no such provision
exists in the ME or the UICC or the provision does not authorize 5G ProSe UE-to-Network Relay
discovery, then the UE is not authorized to transmit;
- The UE is allowed to use “operator-managed” radio resources (i.e. carrier frequency)
provisioned in the ME or the UICC for 5G ProSe UE-to-Network Relay communication if the
UICC indicates it is authorized;
- If the UE intends to use “non-operator-managed” radio resources (i.e. carrier frequency) for 5G
ProSe UE-to-Network Relay communication, according to TS 36.331 [15] or TS 38.331 [16] and
as specified in clause 5.1.4.1, then the UE shall perform 5G ProSe UE-to-Network Relay
communication using resource provisioned in the ME or the UICC. If no such provision exists in
the ME or the UICC or the provision does not authorize 5G ProSe UE-to-Network Relay
communication, then the UE is not authorized to transmit;
NOTE 1: It is possible for operators to configure UEs (e.g. Public Safety UEs) to use only
“operator-managed” radio resources (i.e. carrier frequency) for 5G ProSe UE-to-Network Relay
communication when the UE is “not served by NG-RAN”.
- The UE provisioning shall support setting Geographical Areas;
NOTE 2: It is possible for a UE to use other radio resources for 5G ProSe UE-to-Network Relay
communication based on the Geographical Area instead of those operated by the serving NG-
RAN cell, when provisioned in the UE, even if the UE's serving cell offers normal service and
the SIBs for NR sidelink communication defined in TS 38.331 [16] indicates that the service (5G
ProSe UE-to-Network Relay communication) is available. This is to cover the scenario when e.g.
the radio resources used for 5G ProSe UE-to-Network Relay communication are not owned by
the serving network of the UE.
NOTE 3: When cross-carrier operation is supported, according to TS 36.331 [15] or
TS 38.331 [16], a UE can be instructed by its serving cell to perform 5G ProSe UE-to-Network
Relay communication over a different carrier frequency. The UE is still considered as “served by
NG-RAN” in this case.
NOTE 4: The scenario that a cell is detected and the cell does not provide support for 5G ProSe
UE-to-Network Relay communication when the UE attempts to use a carrier frequency
configured for 5G ProSe UE-to-Network Relay communication, is considered a configuration
error. Therefore, the UE does not transmit on that frequency to avoid interference to the network.
- The 5G ProSe UE-to-Network Relay communication is only specified for NR.
Editor's note: It is FFS whether and how to apply the mobility restriction for UE-to-Network relay
or remote UE.

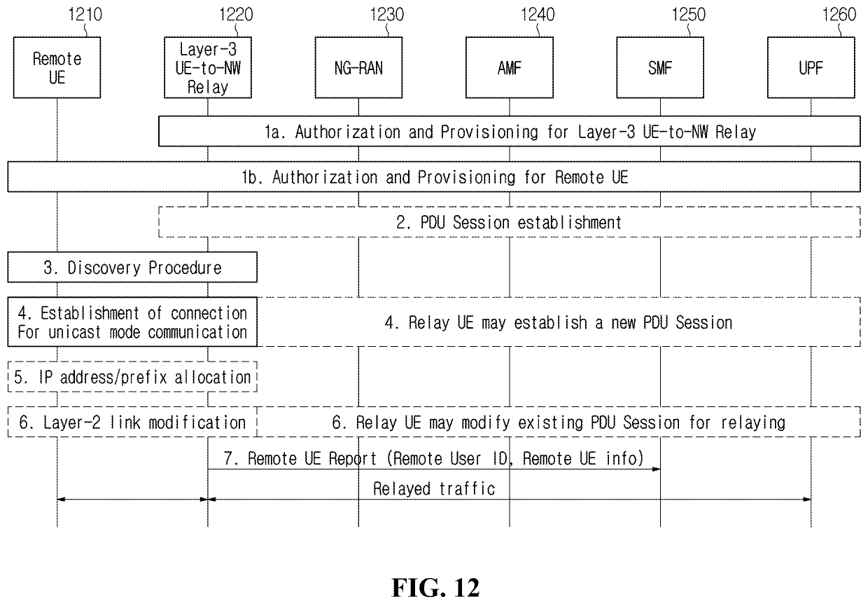

FIG. 12 is a view showing a method of performing ProSe communication based on a UE-to-network relay that is applied to the present disclosure. Referring to FIG. 12, a relay UE 1220 may be registered to a network. As an example, the relay UE 1220 may be a layer-UE-to-network relay but will be referred to as the relay UE 1220 below, for convenience of explanation. Herein, after being registered to the network, the relay UE 1220 may establish a PDU session for providing a relay for a remote UE 1210 or modify a current PDU session for providing the relay. The relay UE 1220 may use the PDU session for relay traffic for the remote UE 1210. In addition, as an example, a serving PLMN of the relay UE 1220 and a PLMN, to which the remote UE 1210 is subscribed, may be identical with or different from each other and may not be limited to a specific form.

Specifically, referring to FIG. 12, service authentication and provisioning for the relay UE 1220 may be performed. In addition, as an example, service authentication and provisioning for the remote UE 1210 may also be performed. Herein, the relay UE 1220 may establish or modify a PDU session for relay. Next, the remote UE 1210 may perform a discovery procedure for the relay UE 1220. Herein, the remote UE 1210 may perceive an accessible service based on the relay UE 1220 through the discovery procedure. Next, the remote UE 1210 and the relay UE may establish connection for unicast mode communication. In case the relay UE 1220 has no PDU session associated with a relay service code or needs a new PDU session for relay, the relay UE 1220 may start a new PDU session establishment procedure before completely establishing PC5 connection. In addition, as an example, the relay UE 1220 may determine a PDU session type for relay. Herein, based on the PDU session type for relay, the relay UE 1220 may perform a relay function in a corresponding layer. Next, an IP address and a prefix may be allocated to the remote UE 1210 and the relay UE 1220. The remote UE 1210 may deliver a PC5 QoS rule to the relay UE 1220, and the relay UE 1220 may generate a packet filter to be used in a Uu interface based on the PC5 QoS rule. Next, the relay UE 1220 may perform PDU session modification and configure a new QoS flow or combine traffic with an existing QoS flow. Next, the remote UE 1210 may perform uplink and downlink relay based on the relay UE 1220. Herein, in case downlink traffic is forwarded, the PC5 QoS rule may be applied to a downlink packet for the PC5 QoS flow. In addition, as an example, in case uplink traffic is forwarded, a 5G QoS rule may be applied to an uplink packet for a Uu QoS flow. Next, the relay UE 1220 may deliver a remote UE report including a remote UE ID and remote UE information for a PDU session associated with relay to an SMF 1250. Herein, the remote UE ID is an ID for identifying a remote UE and may be an identifier of a remote UE that has successfully performed connection with the relay UE 1220. Based on what is described above, the remote UE 1210 may perform traffic exchange to a network through the relay UE 1220. Herein, a core network may perform authentication for a UE that performs connection to the core network. As an example, authentication may be needed for a remote UE that performs connection to the core network through a UE-to-network relay. As an example, in case authentication for a remote UE is not adequately performed, connection by an unauthenticated UE may be performed by a DDoS attack, so that there may be a security problem. In consideration of what is described above, in case a remote UE accesses a core network through a UE-to-network relay, an authentication procedure for the remote UE and the core network may be required.

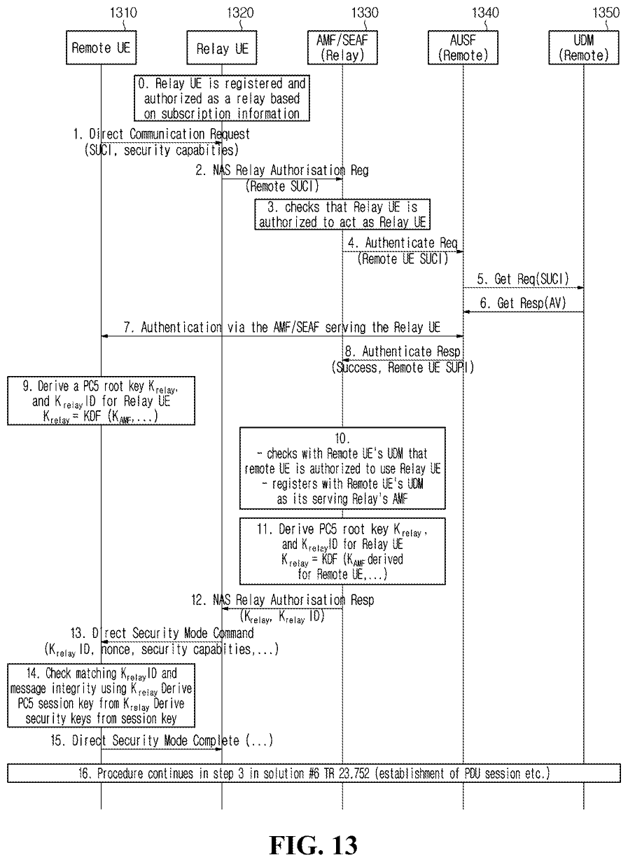

Herein, an authentication and security procedure may be performed based on primary authentication for a remote UE that uses a UE-to-network relay. Specifically, FIG. 13 is a view showing a method of performing an authentication and security procedure based on primary authentication for a remote UE that uses a UE-to-network relay applied to the present disclosure.

Referring to FIG. 13, a relay UE 1320 may perform registration and authentication to serve as a UE-to-network relay. A remote UE 1310 may transmit a direct communication request including a subscription concealed identifier (SUCI) and security capabilities of the remote UE to the relay UE 1320. As an example, in case the remote UE 1310 accesses the same relay UE 1320 again, the direct communication request message may include, ID used in a previous establishment procedure instead of the SUCI. In case the relay UE 1320 holds K_{relay} and K_{relay} ID, the remote UE 1310 and the relay UE 1320 may skip the following connection procedure.

On the other hand, in case the relay UE 1320 receives the direct request message including the SUCI and the security capabilities, the relay UE 1320 may transmit an NAS relay authorization request message to a serving AMF 1330. Herein, the NAS relay authorization request message may include the SUCI of the remote UE. Next, the AMF 1330 of the relay UE may check whether the relay UE is authorized to serve as a relay, based on subscription information obtained from a relay UE registration procedure. Next, the AMF 1330 of the relay UE may start authentication of the remote UE together with an authentication server function (AUSF) 1340 of the remote UE based on a primary authentication procedure.

Herein, the AMF 1330 of the relay UE may deliver an authentication request message including the SUCI of the remote UE to the AUSF 1340 of the remote UE. Herein, as an example, an indicator may be included to indicate that an authentication message between the AMF 1330 of the relay UE and the AUSF 1340 of the remote UE and between the AMF 1330 of the relay UE and the relay UE 1320 is an authentication message for a relay. As an example, the indicator may indicate that authentication of the remote UE 1310 is performed through the relay UE 1320. Next, the AUSF 1340 of the remote UE and user data management (UDM) 1350 of the remote UE may perform authentication based on the SUCI of the remote UE.

Herein, the UDM 1350 does not have to perceive whether the authentication of the remote UE 1310 is based on the relay, but may perform the authentication alone.

Based on authentication information obtained by the UDM 1350, the AUSF 1340 of the remote UE may complete the authentication for the remote UE through the AMF 1330 of the relay UE. Next, the remote UE 1310 may derive PC5 link root keys, that is, K_{relay} and K_{relay} ID from K_{AMF}. As an example, K_{relay} and K_{relay} ID may be identical with K_{NRP} and K_{NRP} ID. However, as an example, K_{relay} and K_{relay} ID may be derived by K_{AMF} in a primary authentication procedure, but K_{NRP} and K_{NRP} ID may be generated long-term credentials after mutual authentication between two entities based on the user plane authentication scheme, which will be described below. However, the present disclosure may not be limited thereto. As an example, after authentication for the remote UE 1310 is successful, the AMF 1330 of the relay UE may check, through the UDM 1350 of the remote UE, whether the remote UE 1310 is authorized to use a UE-to-network relay. In case the AMF 1330 of the relay UE succeeds in checking authentication, the AMF 1330 of the relay UE may register the UDM 1350 of the relay UE as a serving relay AMF and provide an identifier (e.g. SUPI or GPSI) of the relay UE. Next, the AMF 1330 of the relay UE may derive K_{relay} and K_{relay} ID, which are PC5 link root keys, from K_{AMF}.

Next, the AMF 1330 of the relay UE may transmit an NAS relay authorization response to the relay UE 1320. Herein, the NAS relay authorization response may include the above-described K_{relay} and K_{relay} ID. In addition, as an example, the NAS relay authorization response may include an identifier (e.g. GPSI) of the remote UE. Herein, the relay UE 1320 may store the above-described key and the identifier of the remote UE in relation with a PC5 link of the remote UE.

Next, the relay UE 1320 may perform a PC5 link security establishment procedure with the remote UE 1310. Herein, the PC5 link security establishment procedure may be performed based on K_{relay} that is a PC5 link root key. As an example, the relay UE 1320 may derive K_{relay-sess}, which is a PC5 session key, from K_{relay} Next, the relay UE 1320 may derive a confidentiality and integrity key from K_{relay-sess}. Next, the relay UE 1320 may transmit a direct security mode command to the remote UE 1310 based on integrity protection. Herein, the direct security mode command may include at least one of K_{relay} ID and nonce and security capability. Herein, K_{relay} ID may indicate that PC5 security is established based on primary authentication of the remote UE. Next, the remote UE 1310 may check whether K_{relay} ID is matched and check integrity of message through K_{relay}. In addition, the remote UE 1310 may derive a PC5 session key through K_{relay} and derive a security key from the session key. Next, the remote UE 1310 may transmit a direct security mode complete message to the relay UE 1320, and thus authentication may be completed.

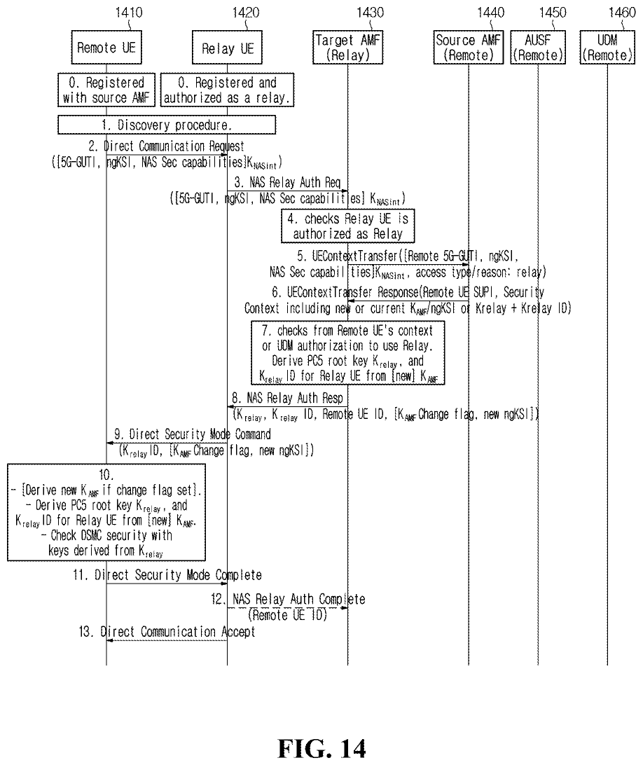

As another example, FIG. 14 is a view showing a method of performing connection to a relay UE based on a security context of a remote UE applied to the present disclosure.

Referring to FIG. 14, a remote UE 1410 may be registered to a network and establish a 5G native security context together with a source AMF 1440. In addition, a relay UE 1420 may authenticate that it serves as a relay, and the relay UE 1420 may be registered to the network. Herein, the remote UE 1410 may perform a discovery procedure together with the relay UE 1420 based on the above-described 5G native security context. As an example, in case the remote UE 1410 perceives a PLMN ID of a serving PLMN of the relay UE, the remote UE 1410 may perceive, together with the serving PLMN of the relay UE, that the 5G native security context is established, before transmitting a 5G-GUTI to the relay UE 1420. As an example, in case the PLMN ID of the serving PLMN of the relay UE and a PLMN ID in the 5G-GUTI are different from each other, the remote UE may transmit instead of a SUCI. On the other hand, in case the remote UE 1410 does not perceive the PLMN ID of the serving PLMN of the relay UE, the remote UE 1410 may opt not to transmit any identifier (e.g. neither SUCI nor 5G-GUTI).

As an example, in case the 5G-GUTI is transmitted, the remote UE 1410 may include the 5G-GUTI, a ngKSI used for identifying K_{AMF}, security capabilities of the remote UE, and current UL NAS COUNT information in a direct communication request message and transmit the direct communication request message. Herein, the above-described parameters may be included with integrity being protected based on the 5G native security context of the remote UE. In case the above-described 5G-GUTI is included in the direct communication request message, the relay UE 1420 may check whether the PLMN ID of the serving PLMN and the PLMN ID in the 5G-GUTI of the remote UE are identical with each other. Herein, the PLMN IDs are not identical with each other, the relay UE 1420 may transmit an identification request message including the serving PLMN ID of the relay UE to the remote UE 1410 and thus obtain an identifier (e.g. SUCI or 5G-GUTI) of the remote UE. As an example, in case the remote UE 1410 transmits the 5G-GUTI of the remote UE and the integrity-protected message to the relay UE 1420 as an identification response, the relay UE may transmit an NAS relay authentication request to a target AMF 1430 of the relay UE. Herein, the NAS relay authentication request may include the 5G-GUTI, ngKSI, NAS security capabilities, and current UL NAS COUNT information. Next, the AMF 1430 of the relay UE may check whether the relay UE is certified to serve as a relay UE and deliver a UE context to the AMF 1440 of the remote UE. Herein, the UE context may include the 5G-GUTI, the ngKSI, the NAS security capabilities, the current UL NAS COUNT information, an access type, and information indicating that the UE is a relay. Next, the AMF 1440 of the remote UE may deliver a UE context response to the AMF 1430 of the relay UE. Herein, the UE context response may transmit a security context including the SUPI of the remote UE, new or current K_{AMF}/ngKSI or K_{relay}/K_{relay} ID to the AMF 1430 of the relay UE.

Herein, the AMF 1430 of the relay UE may check UDM authentication for relay use or a context of the remote UE and derive K_{relay} and K_{relay} ID, which are PC5 root keys, from K_{AMF}. Next, the AMF 1430 of the relay UE may transmit an NAS relay authentication response, which includes K_{relay}, K_{relay} ID, a remote UE ID, a K_{AMF} modification flag, and a new ngKSI, to the relay UE 1420. Next, the relay UE 1420 may transmit a direct security mode command, which includes K_{relay} ID, the K_AMF modification flag and the new ngKSI, to the remote UE 1410. When the K_{AMF} modification flag is configured, the remote UE may derive a new K_{AMF} and derive K_{relay} and K_{relay} ID, which are PC5 root keys, from the K_{AMF}. In addition, the remote UE may perform a security check through the derived K_{relay}. Next, the remote UE 1410 may transmit direct security mode complete to the relay UE 1420 and receive a direct communication accept message from the relay UE 1420. In addition, the relay UE 1420 may transmit NAS relay authentication complete including the remote UE ID to the network.

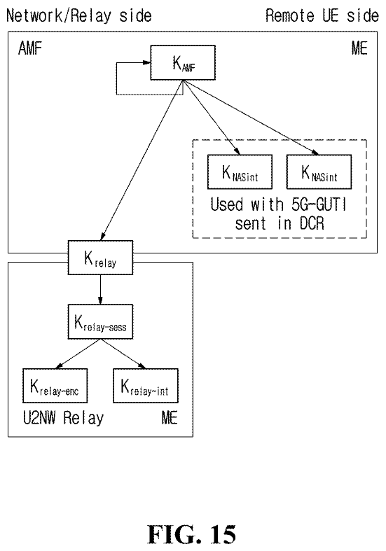

In addition, as an example, the above-described key structure for a PC5 unicast link of a UE-to-network relay may be derived based on Table 4 and FIG. 15 below, and thus the above-described security procedure may be performed. As an example, FIG. 15 may be a view showing a method of deriving and allocating a key when authenticating a remote UE based on a control plane, and a key may be derived and allocated based on Table 4 below.

TABLE 4
6.10.2.3 Key hierarchy, key derivation, and distribution
The Key Hierarchy for PC5 unicast link with UE-to-Network relay is shown in FIG. 6.10.2.3-
1. Details for Krelay and Krelay ID derivation are described next.
Overall, the keys Krelay, Krelay-sess, Krelay-enc, Krelay-int serve a similar function respectively
as KNRP, KNRP-sess, NRPEK, and NRPIK in TS 33.536 [8] clause 5.3.3.1.2.1.
The key derived for access via UE-to-Network relay is Krelay, which is used by UE-to-Network
relay and Remote UE to derive Krelay-sess.
Krelay-sess is derived from Krelay using nonces exchanged during the PC5 link establishment
similarly to how KNRP-sess is derived from KNRP in Annex A.3 of TS 33.536 [8].
When deriving the key Krelay from KAMF and the uplink NAS COUNT in the UE and the AMF
the following parameters are used to form the input S to the KDF.
- FC = 0xXX
- P0 = Uplink NAS COUNT
- L0 = length of uplink NAS COUNT (i.e. 0x00 0x04)
- P1 = Access type distinguisher
- L1 = length of Access type distiguisher (i.e. 0x00 0x01)
The access type distinguisher is set to the value for non-3GPP (0x02) (see Annex A.9 in TS 33.501
[14]).
The input key KEY is KAMF.
When deriving the Krelay ID from KAMF, the following parameters are used to form the input
S to the KDF:
- FC = 0xYY;
- P0 = “R-KID”;
- L0 = length of “R-KID”; (i.e. 0x00 0x05)
- P1 = SUPI;
- L1 = length of SUPI.
The input key KEY is KAMF.
SUPI has the same value as parameter P0 in Annex A.7.0 of TS 33.501 [14].

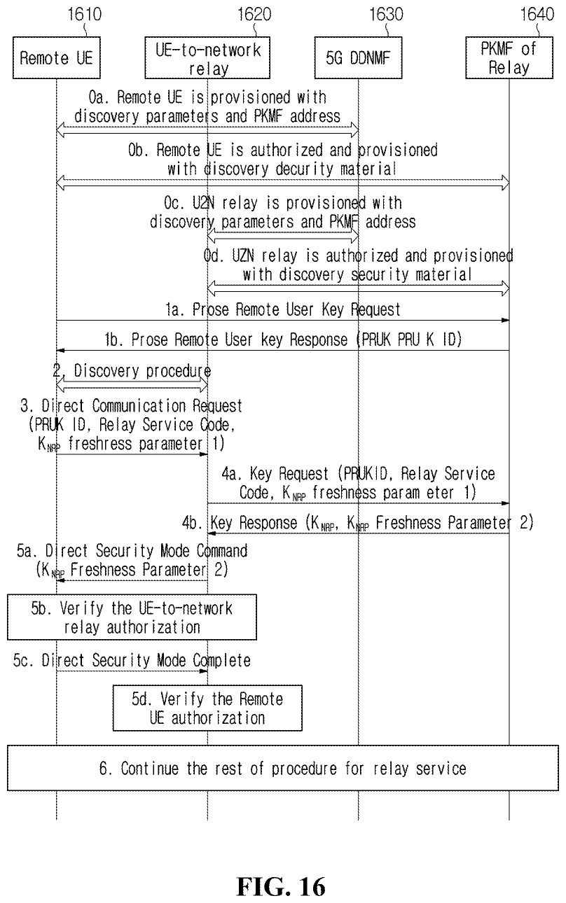

FIG. 16 is a view showing a method of performing authentication for a remote UE based on a PKMF applied to the present disclosure.

Referring to FIG. 16, a PC5 link establishment security and authentication procedure for a UE-to-network relay may be performed. As an example, a remote UE 1610 may be provisioned with a discovery parameter and ProSe key management function (PKMF) address information beforehand based on a 5G direct discovery name management function (5G DDNMF) 1630. As an example, the remote UE 1610 may obtain a plurality of PKMF addresses from different PLMNs. In case the remote UE 1610 receives the plurality of PKMF addresses, the remote UE 1610 may access each PKMF. Herein, the remote UE 1610 may directly access each PKMF or perform the access through a home PLMN of PKMF. In addition, as an example, the remote UE 1610 may perform authentication to receive a UE-to-network relay service and obtain a discovery security material from the PKMF 1640. In addition, a relay UE 1620 may also be provisioned with a discovery parameter and PKMF address information beforehand from the 5G DDNMF 1630. In addition, the relay UE 1620 may obtain certification for serving as a relay and receive the discovery security material from the PKMF 1640.

Next, the remote UE 1610 may transmit a ProSe remote user key (PRUK) request message to the PKMF 1640 of the relay UE. Herein, the PKMF 1640 of the relay UE may check whether the remote UE 1610 has performed authentication to be provided with the UE-to-network relay service. Herein, the PKMF 1640 may confirm an identifier of the remote UE by considering key information based on a security connection between the remote UE 1610 and the PKMF 1640 and thus check whether authentication is performed. Next, the PKMF 1640 may transmit a PRUK response including a PRUK and a PRUK ID to the remote UE 1610. Next, the remote UE 1610 may perform a discovery procedure with the relay UE 1620. Herein, the remote UE 1610 may transmit a direct communication request to the relay UE 1620. The direct communication request may include a PRUK ID, a relay service code, and K_{NRP} freshness parameter 1. Next, the relay UE 1620 may transmit a key request message to the PKMF 1640. Herein, the key request message may include the PRUK ID, the relay service code, and the K_{NRP} freshness parameter 1. Herein, the PKMF 1640 may generate K_{NRP} freshness parameter 2 based on the above-described information and derive K_{NRP} through a PRUK identified by the PRUK ID, the K_{NRP} freshness parameter 1, and the K_{NRP} freshness parameter 2. Next, the PKMF 1640 may transmit a key response message to the relay UE 1620 as a response to the key request message. Herein, the key response message may include K_{NRP} and the K_{NRP} freshness parameter 2. Next, the relay UE 1620 may transmit a direct security mode command to the remote UE 1610. Herein, the direct security mode command may include the above-described K_{NRP} freshness parameter 2. Herein, the remote UE 1610 may derive K_{NRP} through a PRUK, a RSC, the K_{NRP} freshness parameter 1 and the K_{NRP} freshness parameter 2. In addition, the remote UE 1610 may also derive K_{NRP-SESS} based on the same method and derive K_{NRPIK}, which an integrity protection key, and K_{NRPIK}, which is an encryption key, through K_{NRP-SESS}. Next, the remote UE 1610 may check integrity for the direct security mode command, and when the integrity check is successful, may verify authentication for the UE-to-network relay. Next, the remote UE 1610 may transmit a direct security mode complete message to the relay UE 1620. The direct security mode complete message may be transmitted based on encryption and integrity protection. Herein, the relay UE 1620 may perform an integrity protection check, and when the integrity protection check is successful, the relay UE 1620 may perceive that the remote UE 1610 has performed authentication to be provided with a relay service. Next, the remote UE 1610 may communicate with a core network through the relay UE 1620.

What is described above, in case authentication of a remote UE is performed, the remote UE and a relay UE may perform authentication based on a security material that is provided by a PKMF. That is, authentication may be performed based on a PKMF. Herein, as an example, the above-described FIG. 13 and FIG. 14 may perform authentication for a remote UE based on a control plane, and FIG. 16 may perform authentication for remote UE based on a user plane. Herein, in case authentication for a remote UE is performed, it may be necessary to support an authentication scheme for a control plane for the above-described FIG. 13 and FIG. 14 and an authentication scheme for a user plane for FIG. 16.

As an example, in relation to PC5 link security, PC5 keys may be derived through primary authentication. Herein, security communication between a remote UE and a relay UE may be performed through keys that are derived, distributed and shared through a network. Herein, a root credential may be configured between the relay UE and the network, and the shared keys may be individually derived through the remote UE and the network based on the root credential. Herein, the shared keys may be distributed to the relay UE through the network, the remote UE and the relay UE may perform authentication based on what is described above, and this may be authentication for a control plane scheme.

On the other hand, a user plane scheme may be performed through a PKMF. As an example, a new communication system (e.g. 5G) may support a PKMF considering a commercial service, and security keys managed by a PKMF may be used for PC5 communication. Herein, as an example, a new communication system needs to support both authentication for the control plane scheme and authentication for the user plane scheme, which are described above, and an operation for this may be needed, which will be described below.

As an example, in a ProSe UE-to-network relay system, a remote UE may access a core network through a relay UE. Herein, when the remote UE accesses the core network through the relay UE, an authentication procedure between the remote UE and the core network may be needed. In addition, when the authentication between the remote UE and the core network is completed, the remote UE needs to generate an encryption key to be used in PC5 interface communication with the relay UE based on an authentication result. Herein, the remote UE may perform communication, to which security is applied, with the core network based on the generated encryption key. That is, when the remote UE accesses the core network through the relay UE, communication may be performed based on an authentication procedure between the remote UE and the core network.

Herein, as an example, an authentication procedure between a remote UE and a core network through a relay UE may be performed through a control plane signaling message based on the above-described FIG. 13 to FIG. 14. As another example, an authentication procedure between a remote UE and a core network through a relay UE may be performed through user plane data traffic based on the above-described FIG. 16.

That is, an authentication procedure between a remote UE and a core network may be performed based on a control plane or a user plane. As an example, an authentication procedure based on a control plane scheme and a user plane scheme is as described above, may refer to TR 33.847 disclosed before this document but may not be limited thereto.

Herein, as an example, in case a remote UE performs authentication with a core network based on the control plane scheme, the remote UE may perform primary authentication with its home public land mobile network (HPLMN) in the control plane through a network of a relay UE. When the remote UE succeeds in the primary authentication, the remote UE may generate a PC5 root key based on an anchor key that is derived based on the primary authentication, which is the same as described above.

On the other hand, in case authentication between a remote UE and a core network is performed based on the user plane scheme, the remote UE may perform separate authentication through a UE ID based on a ProSe key management function (PKMF) that is connected to the remote UE by IP traffic. Next, the remote UE and a relay UE may obtain a PC5 root key from the PKMF and thus perform PC5 communication, which is the same as described above.

As an example, the control plane scheme and the user plane scheme, which are described above, each have different advantages and disadvantages. As a concrete example, in case a public safety service is provided to a remote UE, the public safety service needs to be provided to every remote UE irrespective of a network to which the remote UE is registered. In the above-described case, when authentication between the remote UE and a core network is performed in a user plane through a PKMF, the service may be provided by performing the authentication irrespective of a network provider, and thus an authentication procedure may be easy.

On the other hand, in the case of a commercial service using a UE relay function, if authentication between a remote UE and a core network is performed by a PKMF based on a user plane, inefficiency may occur. Specifically, in case authentication is performed based on a user plane, a remote UE and a relay UE may access a PKMF before performing communication and be provided with an encryption key. At this time, if the remote UE is incapable of accessing a network (that is, out of coverage), the remote UE may be incapable of accessing the PKMF, and the authentication may be difficult to perform based on the above-described scheme. Herein, the reason why a relay is used based on a commercial service may be because a relay UE is to provide indirect access to the remote UE that is located far from the network and thus has difficulty in directly accessing thereto. Accordingly, a method of demanding remote access to a PKMF in advance may be difficult to apply depending on a UE type.

As another example, in case a PKMF operating subject is not clear or different, an authentication procedure may be inefficient. As an example, in case a remote UE and a relay UE are registered to different networks, it may be unclear which network is to implement and manage a PKMF that the remote UE and the relay UE should commonly access. As an example, even if a network of a relay UE is in charge of a PKMF, a remote UE needs to receive an encryption key by accessing every PKMF associated with every relay UE in advance.

Herein, because a public safety service may promise an entity for operating and managing a PKMF in advance, it may be easy to apply a method of authenticating a remote UE based on a user plane scheme. On the other hand, as described above, because a commercial service is provided based on a plurality of interest parties and the service is provided based on different operating subjects, there may occur a problem.

Considering what is described above, for a commercial service, a primary authentication procedure between a remote UE and a core network needs to be performed based on control plane primary authentication. On the other hand, for a public safety service, since authentication may be managed from outside, the authentication may be performed more efficiently in a user plane irrespective of a network, instead of a control plane scheme where each network is in charge of the authentication. Considering what is described above, authentication between a remote UE and a core network in a ProSe UE-to-network relay system needs to support both the user plane scheme and the control plane scheme. Herein, a specific scheme out of the user plane scheme and the control plane scheme may be selectively applied based on a type of a provided service, and a method therefor will be described below.

A remote UE and a relay UE may each be provisioned with necessary information for a relay service beforehand from a policy control function (PCF). Herein, the information provisioned to the remote UE and the relay UE may be a ProSe relay service code (RSC) and security parameters associated therewith. That is, the provisioned information may include information on the relay service and a security parameter corresponding to the relay service. Herein, as an example, the security parameter may include PKMF address information based on a RSC type. In case the PCF does not perceive the PKMF address, the PKMF address information may be set as a default value. Thus, the PCF may deliver information indicating that the PKMF should be used to the remote UE and the relay UE. Herein, as an example, the information indicating that the PKMF should be used may not be limited to the PKMF address but may be information on a different form of indicator indicating an authentication scheme, and an authentication scheme of the remote UE may be indicated through what is described above.

As an example, the information that the PKMF should be used may be indicated based on a first indicator. Herein, in case the provisioned information includes the first indicator, it may be indicated that the authentication scheme is performed based on the PKMF. That is, it may be indicated that the authentication scheme is a user plane authentication scheme. On the other hand, in case the provisioned information does not include the first indicator, it may be indicated that the authentication scheme is a control plane scheme.

As another example, provisioned information may include a first indicator. Herein, in case the first indicator indicates a user plane authentication scheme, an authentication scheme may be indicated to be performed based on the user plane authentication scheme based on a PKMF. On the other hand, in case the first indicator indicates a control plane authentication scheme, an authentication scheme may be indicated to be performed based on the control plane authentication scheme but is not limited the above-described embodiment. As another example, in case no PKMF is used according to a RSC, a PCF may not provision corresponding information.

That is, only when a PKMF is used, the PCF may transmit PKMF address information based on the RSC or PKMF address information set to a default value to a remote UE and a relay UE. On the other hand, when no PKMF is used, the PCF may not transmit PKMF address information to the remote UE and the relay UE.

As an example, in case there is no PKMF address information associated with a RSC, a remote UE may perform authentication based on a control plane scheme after a direct discovery operation through a direct discovery name management function (DDNMF). That is, the remote UE may include and transmit a subscription concealed identifier (SUCI) in a PC5 direct communication request (DCR) to a relay UE and thus perform authentication based on the control plane scheme, which is the same as described above.

As another example, in case another form of indicator information associated with a RSC includes information indicating that authentication is performed based on a control plane scheme, a remote UE may perform authentication based on the control plane scheme after a direct discovery operation through DDNMF. That is, the remote UE may include and transmit a SUCI in a PC5 DCR to a relay UE and thus perform authentication based on the control plane scheme, which is the same as described above.

On the other hand, in case there is PKMF address information associated with a RSC, a remote UE and a relay UE may transmit a discovery request including the RSC and provisioned PKMF address information to a DDNMF. Herein, the DDNMF may check the RSC and the PKMF address information included in the request message and determine whether a corresponding PKMF address is the same as a set value. As an example, when the PKMF address information is not identical, the DDNMF may transmit a discovery response including information on a set value in the DDNMF to the remote UE and the relay UE. Next, the remote UE and the relay UE may generate a security channel by performing authentication with a PKMF based on the PKMF address information and security information and receive a PC5 key and a key ID from the PKMF. Next, the remote UE may transmit a PC5 DCR including the obtained key ID to the relay UE.

As another example, in case another form of indicator information associated with a RSC includes information indicating that authentication is performed based on a user plane scheme, as described above, authentication of a remote UE may be performed in a user plane based on a PKMF. Herein, as an example, when another form of indicator information receives information indicating that authentication is performed based on the user plane scheme, a PKMF address may be set to a random value but is not limited to the above-described embodiment.

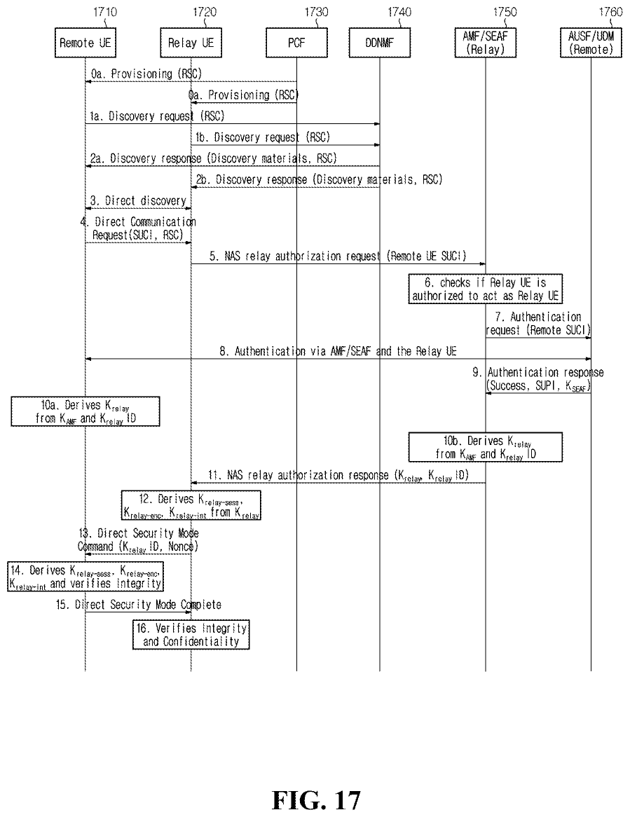

FIG. 17 is a view showing a method of performing authentication between a remote UE applied to the present disclosure and a core network based on a control plane scheme.

As an example, referring to FIG. 17, a remote UE 1710 and a relay UE 1720 may be provisioned with information on a ProSe UE-to-network relay from a PCF 1730. Herein, in case PKMF address information is not included in the provisioned information, the remote UE 1710 and the relay UE 1720 may perform authentication based on a control plane scheme.

Specifically, in FIG. 17, the PCF 1730 may provision necessary information for the UE-to-network relay to each of the remote UE 1710 and the relay UE 1720. Herein, the provisioned information may include RSC information for distinguishing a relay service, as described above.

Next, the remote UE 1710 and the relay UE 1720 may each transmit a discovery request including necessary information for PC5 direct discovery to a DDNMF. Herein, as an example, the discovery request may include a RSC. In addition, as an example, because the provisioned information does not include PKMF address information, the discovery request may not include the PKMF address information. As another example, the provisioned information may include information indicating that authentication for a control plane scheme is performed based on another form of indicator information, as described above. Next, the DDNMF may deliver a discovery response including discovery and security information necessary according to the above-described direct discovery type (e.g. open or restricted/Model A or Model B) mapped to the RSC to the remote UE 1710 and the relay UE 1720 respectively.

Next, the remote UE 1710 may discover a relay UE based on the information obtained from the DDNMF and select the relay UE 1720 to be accessed. Herein, the remote UE 1710 may transmit a DCR message as a PC5 message to the relay UE 1720. As an example, the DCR message may include a SUCI and a RSC that are protected by a public key of an HPLMN of the remote UE 1710. The relay UE 1720 may receive the DCR message from the remote UE 1710 and perceive the RSC in the DCR message. Herein, the DCR message may not include the PKMF address information. Accordingly, the relay UE 1720 may perceive that there is no PKMF address information associated with the RSC and perform authentication for the remote UE 1710 based on a control plane scheme. As an example, when performing the authentication for the remote UE 1710 based on the control plane scheme, the relay UE 1720 may transmit an NAS relay authorization request to an access and mobility management function (AMF)/security anchor function (SEAF) 1750. Herein, the NAS relay authorization request may include a SUCI of the remote UE 1710. Next, the AMF/SEAF 1750 may authenticate, based on subscription information, whether a UE transmitting the NAS relay authorization request is allowed to operate as the relay UE 1720. Herein, when the UE transmitting the NAS relay authorization request is allowed to operate as the relay UE 1720 (that is, authentication is successful), the AMF/SEAF 1750 may deliver the SUCI of the remote UE 1710 to an authentication server function (AUSF)/user data management (UDM) 1760 of the remote UE 1710 to request authentication of the remote UE 1710. Herein, as an example, the HPLMN of the remote UE 1710 and an HPLMN of the relay UE 1720 may be identical with each other. As another example, even when the HPLMN of the remote UE 1710 and the HPLMN of the relay UE 1720 are different from each other, they may be applied in a same manner and are not limited to a specific embodiment. Next, the AUSF/DUM 1760 may obtain the SUPI by de-concealing the received SUCI of the remote UE 1710 and read out an authentication vector (AV) corresponding to the SUPI from the UDM. Based on what is described above, primary authentication (5G AKA or EAP-AKA) with the remote UE 1710 may be performed through the relay UE 1720 and a network of the relay UE 1720. As an example, when the authentication is successful, the AUSF 1760 of the remote UE 1710 may generate K_{SEAF} and deliver K_{SEAF} together with the SUPI and authentication result to the AMF/SEAF 1750 of the relay UE 1720. Herein, the AMF/SEAF 1750 may derive K_{AMF} from K_{SEAF} based on a preset scheme and derive K_{relay} (key for NR PC5), which is a root key available in PC5 communication between the remote UE 1710 and the relay UE 1720, and K_{relay} ID for distinguish the key from K_{AMF}. Next, the remote UE 1710 may calculate K_{relay} and K_{relay} ID based on the same scheme as the AUSF 1760 and the AMF/SEAF 1750.

In addition, as a response to the NAS relay authorization request transmitted from the relay UE 1720, the AMF 1750 may include and transmit PC5 root key K_{relay} and K_{relay} ID in an NAS relay authorization response to the relay UE 1720. Herein, the relay UE 1720 may derive K_{relay-sess} (key for NR PC5 session) by using the received K_{relay} and a nonce, which is randomly generated, and derive K_{relay-enc} (key for NR PC5 encryption) and K_{relay-int} (key for NR PC5 integrity), which are to be used for encryption and integrity protection, from K_{relay-sess}.

Next, the relay UE 1720 may transmit a direct security mode command control message to the remote UE 1710. Herein, the direct security mode command control message may include the above-described nonce value to be used for calculating K_{relay-sess} from K_{relay} in order to distinguish a root key used for deriving an encryption key. In addition, as an example, the direct security mode command control message may be delivered including K_{relay-int} based on integrity protection.

Next, the remote UE 1710 may select the root K_{relay} by the received K_{relay} ID and derive K_{relay-sess}, K_{relay-enc} and K_{relay-int} by using the received nonce, as described above. Next, the relay UE 1720 may verify integrity of the received direct security mode command. In case the integrity verification is successful, the remote UE 1710 may transmit a direct security mode complete message to the relay UE 1720. Herein, the direct security mode complete message may be encrypted based on and K_{relay-enc} and K_{relay-int} integrity protection may be performed. Next, the relay UE 1720 may complete the authentication for the remote UE 1710 by verifying integrity for and decoding the received direct security mode complete message by using the encrypted keys based on what is described above.

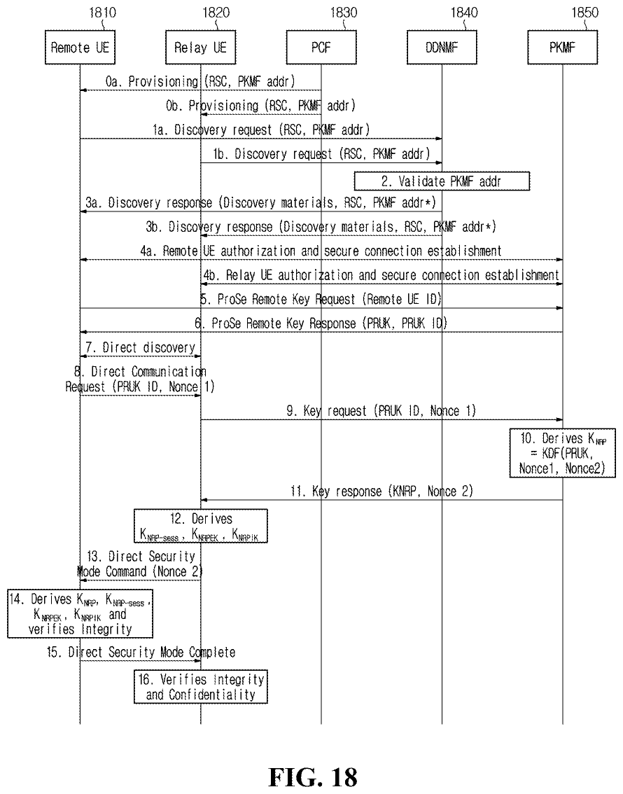

In addition, as an example, FIG. 18 is a view showing a method of performing authentication between a remote UE applied to the present disclosure and a core network based on a user plane scheme. Referring to FIG. 18, a remote UE 1810 and a relay UE 1820 may be provisioned with necessary information for a UE-to-network relay beforehand from a PCF 1830. Herein, the provisioned information may include a RSC and PKMF address information for distinguishing a relay service. As another example, the provisioned information may include another form of indicator information, and the indicator information may include information that instructs user plane authentication to be performed. Herein, as an example, in case another form of indicator information is included, it may be determined that the PCF does not perceive the PKMF address information, and thus a PKMF may be delivered with a random value being set thereto, as described above.

On the other hand, in case the PCF perceives the PKMF address information, a corresponding value may be included in the PKMF address. Herein, the PKMF address information may be address information of a PKMF through which the remote UE 1810 and the relay UE 1820 may receive a security key.

Herein, the inclusion of the PKMF address information in the provisioned information may mean that authentication between the remote UE 1810 and a core network for the RSC is performed based on a user plane scheme. As an example, in case the PCF 1830 perceives the PKMF address information for the RSC, the PCF 1830 may deliver the PKMF address information as provisioned information to the remote UE 1810 and the relay UE 1820. On the other hand, in case authentication is performed based on the user plane scheme but the PCF 1830 fails to perceive the PKMF address information, the PCF 1830 may set the PKMF address information to a random value (e.g. default value) and deliver the PKMF address information to the remote UE 1810 and the relay UE 1820. That is, the PCF 1830 may indicate that the authentication of the remote UE 1810 is performed based on the user plane scheme.

Next, the remote UE 1810 and the relay UE 1820 may each transmit a discovery request for requesting necessary information for PC5 direct discovery to a DDNMF 1840. Herein, the discovery request may include a RSC and PKMF address for the RSC. Herein, when the DDNMF 1840 receives the discovery request from the remote UE 1810 and the relay UE 1820, the DDNMF 1840 may check the RSC and the PKMF address information included in the discovery request. In addition, the DDNMF 1840 may perceive based on the PKMF address information that authentication of the remote UE 1810 for the RSC is performed based on a user plane scheme. Herein, as an example, the DDNMF 1840 may determine whether a PKMF address stored thereon is the same as the PKMF address information included in the discovery request.

Herein, in case the PKMF address information included in the discovery request is a random value (e.g. default value), the DDNMF 1840 may perceive that a user plane authentication scheme is performed. That is, the random value may be used to indicate user plane authentication. In addition, as an example, in case the PKMF address information stored in the DDNMF 1840 and the received PKMF address information from the discovery request are different from each other, the DDNMF 1840 may perceive that PKMF address information for the RSC is modified and use the PKMF address of the DDNMF 1840 first. That is, in case the received PKMF address information is a random value or is different from a value stored thereon, the DDNMF 1840 may prefer and deliver the PKMF address information stored thereon to the remote UE 1810 and the relay UE 1820.

In addition, as an example, in case the DDNMF 1840 does not store a PKMF address for the RSC, the DDNMF 1840 may deliver information indicating that authentication for the remote UE 1810 is inexecutable to the remote UE 1810 and the relay UE 1820. In addition, as an example, in case a PKMF address receive by the DDNMF 1840 and a PKMF address stored in the DDNMF 1840 are identical with each other, the DDNMF 1840 may use the address information.

Herein, the DDNMF 1840 may deliver a discovery response, which includes a RSC, discovery and security information necessary according to a direct discovery type (e.g. open or restricted/Model A or Model B) mapped to the RSC, and PKMF address information associated with the RSC, to the remote UE 1810 and the relay UE 1820.

Next, based on the above-described PKMF address information, the remote UE 1810 and the relay UE 1820 may access the PKMF 1850 and configure authentication of the remote UE 1810 and security connection. As an example, a user plane authentication scheme may be implemented based on authentication and key management for applications (AKMA) or a generic bootstrapping architecture (GBA) protocol, but may not be limited thereto.

Herein, the remote UE 1810 may transmit a ProSe remote key request including a remote UE ID to the PKMF 1850. Herein, the PKMF 1850 may authenticate the remote UE 1810 based on the remote UE ID and generate and deliver a ProSe relay user key (PRUK) as a root key necessary for deriving a security key available for security connection to the relay UE 1820 later and a PRUK ID for distinguish the root key to the remote UE 1810.

Next, the remote UE 1810 may perform mutual discovery with the relay UE 1820 based on the above-described discovery information, and the remote UE 1810 may select the relay UE 1820 to be accessed. Herein, the remote UE 1810 may include the above-described PRUK ID and Nonce 1 required for deriving a PC5 security key later in a direct communication request (DCR), which is a PC5 message, and transmit the message to the selected relay UE 1820. The relay UE 1820 may transmit the key request message including the PRUK ID and Nonce 1, which is received from the remote UE 1810, to the PKMF 1850. Herein, the PKMF 1850 may select a PKMF indicated by the delivered PRUK ID, generate K Nonce 2 in addition to the delivered Nonce 1, and calculate K_{NRP} that the relay UE 1820 may use for PC5 security connection. Herein, K_NRP may be generated based on Formula 1 below. That is, K_{NRP} may be calculated based on PRUK, Nonce 1, and Nonce 2.

$$KNRP = KDF ( PRUK , Nonce 1 , Nonce 2 ) \qquad [ Formula 1 ]$$

Next, the PKMF 1850 may transmit a key response message to the relay UE 1820. Herein, the key response message may include K_{NRP} and Nonce 2. Next, the relay UE 1820 may derive K_{NRP-SESS} key for NR PC5 session) through the delivered K_{NRP} and derive K_{NRPEK}(key for NR PC5 encryption) and K_{NRPIK} (key for NR PC5 integrity) from K_{NRP-SESS} which are to be used for encryption and integrity protection. Next, the relay UE 1820 may transmit a direct security mode command control message to the remote UE 1810. Herein, the direct security mode command control message may include Nonce 2 used in the PKMF 1850 in order to derive the same K_{NRP}.

The remote UE 1810 may generate the same K_{NRP} as the PKMF 1850 by using the received Nonce 2, a PRUK held by the remote UE 1810, and Nonce 1. In addition, based on the above-described method, K_{NRP-SESS}, K_{NRPEK}, and K_{NRPIK} may be derived. Herein, when the key derivation is completed, the remote UE 1810 may verify integrity of the direct security mode command control message received from the relay UE 1820 through K_{NRPIK}. In case the integrity verification is successful, the remote UE 1810 may transmit the direct security mode command control message to the relay UE 1820. Herein, the direct security mode command control message may be encrypted and integrity-protected through K_{NRPEK} and K_{NRPIK}. Next, the relay UE 1820 may perform integrity verification and decoding for the received direct security mode command control message by using the derived encryption keys, and when both are successful, the relay UE 1820 may finish the authentication of the remote UE 1810.

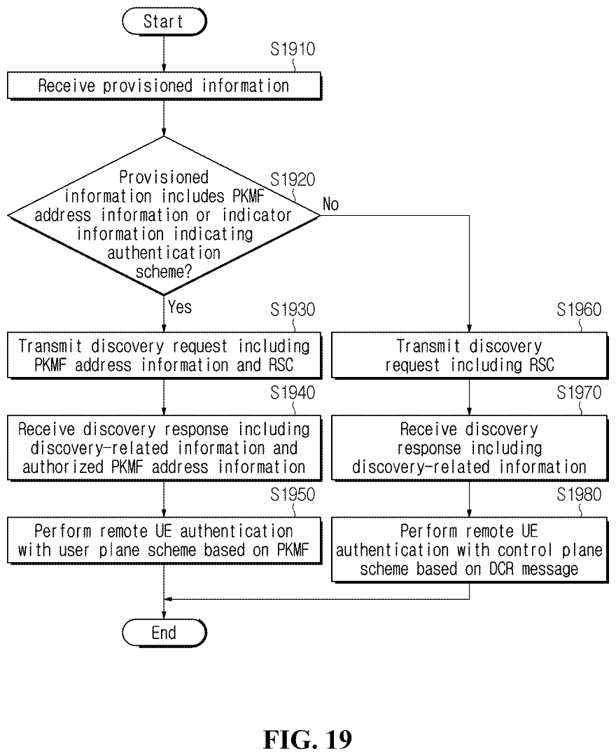

FIG. 19 is a flowchart showing an operating method applied to the present disclosure. Referring to FIG. 19, a remote UE and a relay UE may receive provisioned information (S1910). Herein, the provisioned information may be information on an authentication scheme for the remote UE. As an example, in case the provisioned information includes PKMF address information or indicator information indicating an authentication scheme (S1920), the remote UE may transmit a discovery request including the PKMF address information and a RSC (S1930). Herein, as an example, the description is based on a case where the provisioned information includes the PKMF address information, and the indicator information indicating an authentication scheme will be described later. Next, the remote UE may receive a discovery response including discovery-related information and authorized PKMF address information (S1940). Next, the remote UE may perform authentication with a user plane scheme based on a PKMF (S1950). Herein, when the authentication is performed based on the user plane scheme, the remote UE may request and receive a security key from a PKMF corresponding to the PKMF address information. Next, the remote UE may connect to a network through a second UE and perform authentication based on the received security key. Herein, a request message of the remote UE for requesting the security key to the PKMF may include identification information of the remote UE. In addition, the remote UE may generate security key-related information based on the security key and transmit a DCR message including the information to a relay UE. The relay UE may transmit the key request message including the security key-related information to the PKMF and thus perform authentication for the remote UE.

On the other hand, in case the provisioned information does not include PKMF address information, the remote UE may transmit a discovery request including a RSC (S1960). Next, the remote UE may receive a discovery response including discovery-related information (S1970) and perform the remote UE authentication with a control plane scheme based on a DCR message (S1980). Herein, necessary information for direct discovery between UEs, which is received by the remote UE, may include discovery-related information. The remote UE may generate a SUCI based on the discovery-related information and transmit a DCR message including the SUCI to a relay UE. The relay UE may transmit an NAS relay authentication request message including the SUCI to an AMF of the relay UE, and the AMF of the relay UE may connect to a network and perform authentication by requesting the authentication to an AUSF of the remote UE through the SUCI of the remote UE.

Herein, as an example, indicator information indicating an authentication scheme at the above-described step S1920 may be a first indicator as information indicating that a PKMF should be used. Herein, in case the provisioned information includes the first indicator, the authentication scheme may be indicated to be performed based on a PKMF. That is, the authentication scheme may be indicated to be a user plane authentication scheme. On the other hand, in the provisioned information does not include the first indicator, the authentication scheme may be indicated to be a control plane scheme. As another example, the provisioned information may include the first indicator. Herein, in case the first indicator indicates the user plane authentication scheme, the authentication scheme may be indicated to be performed based on the user plane authentication scheme based on a PKMF. On the other hand, in case the first indicator indicates the control plane authentication scheme, the authentication scheme may be indicated to be performed based on the control plane authentication scheme but is not limited to the above-described embodiment.

As the examples of the proposal method described above may also be included in one of the implementation methods of the present disclosure, it is an obvious fact that they may be considered as a type of proposal methods. In addition, the proposal methods described above may be implemented individually or in a combination (or merger) of some of them. A rule may be defined so that information on whether or not to apply the proposal methods (or information on the rules of the proposal methods) is notified from a base station to a terminal through a predefined signal (e.g., a physical layer signal or an upper layer signal).

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

### INDUSTRIAL APPLICABILITY

The embodiments of the present disclosure are applicable to various radio access systems. Examples of the various radio access systems include a 3^{rd} generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1-21. (canceled)

22. A method performed by a first user equipment (UE) in a wireless communication system, the method comprising:
transmitting a discovery request message;
receiving a discovery response message;
transmitting, to a second UE relaying the first UE, a direct communication request message including information related to a procedure including an authentication; and
wherein the procedure including the authentication is performed based on the information,
wherein the information is provisioned in the first UE and the second UE.

23. The method of claim 22, wherein the first UE is supports performing the procedure including the authentication based on a proximity-based service (ProSe) UE-to-network relay service.

24. The method of claim 23, wherein the information includes a relay service code related to the ProSe UE-to-network relay service.

25. The method of claim 24, wherein the procedure including the authentication is performed based on a indicator.

26. The method of claim 25, wherein the procedure including the authentication is performed over a control plane or a user plane based on whether the information includes the indicator.

27. The method of claim 25, wherein the information includes the indicator,
wherein, based on the indicator indicating a first scheme, the procedure including the authentication is performed over the control plane, and
wherein, based on the indicator indicating a second scheme, the procedure including the authentication is performed over the user plane.

28. The method of claim 24, wherein, in case that the information related to the procedure includes ProSe key management function (PKMF) address information, the procedure including the authentication is performed over a user plane, and
wherein, in case that the information related to the procedure does not include the PKMF address information, the procedure including the authentication is performed over a control.

29. The method of claim 28, wherein, in case that the procedure including the authentication is performed over the user plane, the discovery request message includes the PKMF address information,
wherein the first UE requests and receives a security key from a PKMF corresponding to the PKMF address information,
wherein the authentication performed based on the received security key.

30. The method of claim 29, wherein the discovery request message further includes identification information of the first UE.

31. The method of claim 29, wherein the direct communication request message includes security key-related information generated based on the security key, and
wherein the second UE transmits a key request message including the security key-related information to the PKMF.

32. The method of claim 29, wherein, based on the information related to a procedure including an authentication including default information as the PKMF address information, the procedure including the authentication is performed over the user plane.

33. The method of claim 32, wherein, based on the PKMF address information being the default information, the discovery request message includes the default information, and the discovery request message is transmitted to a direct discovery name management function (DDNMF), and
wherein valid PKMF address information is derived by the DDNMF and is delivered to the first UE.

34. The method of claim 33, wherein the first UE requests and receives a security key from a PKMF corresponding to the valid PKMF address information delivered from the DDNMF and the procedure including the authentication based on the received security key.

35. The method of claim 26, wherein, in case that the procedure including the authentication is performed over the control, the discovery response message includes discovery-related information, and the procedure including the authentication is performed based on the discovery-related information.

36. The method of claim 35, further comprising:
generating a subscription concealed identifier (SUCI) through the identification information of the first UE based on the discovery response message, and
wherein the direct communication request message includes the SUCI to the second UE.

37. The method of claim 36, wherein the second UE transmits an NAS relay authentication request message including the SUCI to an access and mobility management function (AMF) of the second UE,
wherein the AMF of the second UE checks whether a relay role of the second UE is authenticated and transmits an authentication request message to an authentication server function (AUSF) of the first UE based on the SUCI.

38. A first user equipment (UE) in a wireless communication system, the first UE comprising:
at least one transceiver;
at least one processor coupled to the at least one transceiver,
wherein the at least one processor is configured to:
transmit a discovery request message;
receive a discovery response message;
transmit, to a second UE relaying the first UE, a direct communication request message including information related to a procedure including an authentication; and
wherein the procedure including the authentication is performed based on the information,
wherein the information is provisioned in the first UE and the second UE.

39. A second user equipment (UE) relaying a first UE in a wireless communication system, the second UE comprising:
at least one transceiver;
at least one processor coupled to the at least one transceiver,
wherein the at least one processor is configured to:
transmit a discovery request message;
receive a discovery response message;
receive, from the first UE a direct communication request message including information related to a procedure including an authentication; and
wherein the procedure including the authentication is performed based on the information,
wherein the information is provisioned in the first UE and the second UE.
